(19) United States
(12) Patent Application Publication
(10) Pub. No.: US 2026/0095335 A1
(43) Pub. Date: Apr. 2, 2026

(54) SYSTEMS AND METHODS FOR TRUSTED EXECUTION ENVIRONMENT GROUP CREATION

(71) Applicant: SplitSecure Inc, Caldwell, ID (US)

(72) Inventor: Marc-André Tremblay, Longueuil (CA)

(21) Appl. No.: 19/340,449

(22) Filed: Sep. 25, 2025

Related U.S. Application Data
(60) Provisional application No. 63/700,126, filed on Sep. 27, 2024.
(60) Provisional application No. 63/700,558, filed on Sep. 27, 2024.
(60) Provisional application No. 63/700,582, filed on Sep. 27, 2024.
(60) Provisional application No. 63/700,594, filed on Sep. 27, 2024.

(51) Int. Cl. H04L 9/32; G06F 21/57; H04L 9/00; H04L 9/08

(52) U.S. Cl. CPC H04L 9/3263; G06F 21/57; H04L 9/006; H04L 9/085; H04L 9/0861; H04L 2209/463

(57) ABSTRACT

Techniques include: receiving, by a first device from a second device, second device identity evidence including: a second device identifier; and a second device attestation; generating, by the first device, a team proposal including: a team proposal identifier; and team attributes; sending, by the first device to the second device, the proposal; receiving, by the first device from the second device, a team join pledge including: the proposal identifier; and a public key; generating, by the first device, a root secret, shares of the root secret, and a first subset of the shares of the root secret; encrypting, by the first device using the public key, the first subset of the shares to generate a first encrypted set of shares of the root secret; and sending, by the first device to the second device, the first encrypted set of shares of the root secret for storage.

### RELATED APPLICATIONS

The application claims benefit of and priority to U.S. Provisional Ser. No. 63/700,126 titled “GROUP CREATION FOR SECRET SHARING WITH THRESHOLD DEVICES” filed Sep. 27, 2024, to U.S. Provisional Ser. No. 63/700,558 titled “GROUP MANAGEMENT AND DISSOLUTION FOR SECRET SHARING WITH THRESHOLD DEVICES” filed Sep. 27, 2024, to U.S. Provisional Ser. No. 63/700,582 titled “EXTRACTING SECRETS USING SHARES DISTRIBUTED AMONG THRESHOLD DEVICES” filed Sep. 27, 2024, and to U.S. Provisional Ser. No. 63/700,594 titled “HIGHER ORDER SECRET SHARING USING THRESHOLD DEVICES” filed Sep. 27, 2024, which are each hereby incorporated by reference in their entireties.

### TECHNICAL FIELD

The present disclosure relates generally to secret sharing, and more particularly, to implementing secret sharing by intelligently distributing portions of a secret to different computer hardware devices.

### BACKGROUND

The terms “secret sharing” and “secret splitting” are commonly used to refer to the cryptographic concept of distributing a secret among a group. The secret is split in the form of “shares” in such a way that no individual holds any intelligible information about the secret, and that the secret can be reconstructed when a sufficient number of individuals combine their “shares. ” Traditionally, schemes for secret sharing involved a “dealer” and n “players,” where n is an integer larger than one. In one such scheme, the dealer gives one or more shares of the secret to each player, and the players are able to reconstruct the secret from their respective shares only when specific conditions are fulfilled. The dealer accomplishes this by giving each player a share in such a way that a group of t players—where t is a minimum value that defines a threshold of shares—can together reconstruct the secret. Such a scheme is called a (t, n)-threshold scheme or (n, t)-threshold scheme.

### SUMMARY

Secret sharing schemes are good candidates for securing information that is highly sensitive and highly important, especially where traditional encryption schemes are ill-suited (e.g., because sufficient confidentiality or reliability cannot be achieved, or because access control cannot prevent an individual or group from monopolizing access). As such, secret sharing has been implemented in a variety of industries over the last several decades. However, as the capabilities and interconnectivity of computing systems (or simply “systems”) improve, conventional secret sharing schemes are becoming impractical (and in some cases, impossible) to implement. Simply put, conventional secret sharing schemes have multiple practical difficulties that can prevent the protocols from being widely used by modern systems.

As a first example, when a secret is split into shares, the system or process that splits the secret may have implicit access to the secret during splitting. Thus, if the system or process is not effectively protected, the secret may be compromised. Further, if a user does not store her/his share on effectively protected media, the share may be compromised. For example, shares of a secret stored on company laptops may be accessed by an information technology (IT) manager at the company, who has access to all password-protected technology in the company. If enough shares needed to reconstitute the secret are stored on company laptops, the IT manager then has implicit access to the secret.

As a first example, a group of users with access to a secret may need to be centrally managed. This management may be necessary to, for example, meet regulations set by the government, a financial regulatory body, industry norms, etc. Such regulations typically require that a user's access to a secret can be invalidated if the user's credentials are reported missing or stolen. However, a few practical difficulties exist in relation to these regulations. For example, if an individual has the power to arbitrarily add or remove users from the group, then the individual has the implicit power to make themself the only user of the group, thus giving them sole access to the secret and voiding the purpose of splitting the secret amongst a group. As another example, some regulations specify voiding stolen or compromised credentials. If no user has any power to remove users from the group and a group user's credentials are stolen, the system is not in compliance with the regulations.

As another example, management can be necessary for ensuring security of a secret when one or more shares are compromised. In particular, the system may need a way of removing a user's access to a share of the secret when access to the share has been compromised. For example, a user may use her/his credentials to access her/his share of a secret. If the user's credentials are stolen and the system cannot remove access to the share by those credentials, then the stolen credentials are a persistent threat to the secret.

As yet another example, recombining shares of a secret can also include practical difficulties. After a secret is reconstituted from the shares, the secret may be at risk of being stolen unless appropriate precautions are taken. Further, the shares may also be susceptible to being individually stolen during the recombination process or when in transit between devices. Thus, the shares and method of reconstitution can benefit from protections to prevent an attacker from stealing the shares or the secret. Conventional secret sharing schemes generally do not meet the above-mentioned requirements, void security benefits of splitting the secret, or have been proven to be impractical for implementation in industry.

Conventional secret sharing systems are difficult to implement securely in modern distributed environments. In particular, when secrets are split into shares and recombined, existing approaches can fail to (i) prevent a dealer or system component from having implicit access to the full secret during splitting or recombination, (ii) enforce revocation of compromised devices or credentials without compromising the system, and (iii) provide hardware-rooted assurances that only trusted devices participate in secret operations. As a result, traditional schemes are vulnerable to insider access, compromised endpoints, and regulatory non-compliance.

The disclosed systems and methods provide a technical solution at by, for example, implementing secret sharing within a trusted execution environment (TEE) across multiple threshold devices. Secrets are not reconstructed outside the TEE, and reconstitution occurs upon satisfaction of a programmable voting scheme enforced at the hardware level. Additional mechanisms such as platform attestation, ephemeral encryption keys for vote secrecy, audit logging, and a missing piece service ensure that secrets cannot be accessed or misused by a single device, operator, or attacker. These hardware-assisted processes improve the security and reliability of secret management in distributed computing environments and provide a concrete technical improvement over conventional secret sharing schemes.

Provided in some embodiments, operations include: sending, by a first device to a second device, a proposal, the proposal including: a proposal identifier; an operation intent; and a public key of a cryptographic key pair including the public key and a corresponding private key; receiving, by the first device from the second device, an approval vote for the proposal, the approval vote including: the proposal identifier; and an encrypted set of shares including a subset of shares of a root secret encrypted using the public key; decrypting, by the first device using the private key, the encrypted set of shares to generate a decrypted subset of shares; determining, by the first device based on applying the decrypted subset of shares toward a voting shares threshold, satisfaction of the voting shares threshold; reconstituting, by the first device responsive to the satisfaction of the voting shares threshold, the root secret using the decrypted subset of shares; and executing, by the first threshold device, the operation intent using the root secret reconstituted.

Provided in some embodiments, operations include: receiving, by a first device from a second device, second device identity evidence including: a second device identifier; and a second device attestation; generating, by the first device, a team proposal including: a team proposal identifier; and team attributes; sending, by the first device to the second device, the team proposal; receiving, by the first device from the second device, a team join pledge including: the team proposal identifier; and a public key corresponding to a private key of a cryptographic key pair; generating, by the first device, a root secret; generating, by the first device, shares of the root secret; generating, by the first device, a first subset of the shares of the root secret; encrypting, by the first device using the public key, the first subset of the shares of the root secret to generate a first encrypted set of shares of the root secret; and sending, by the first device to the second device, the first encrypted set of shares of the root secret for storage by the second device.

### BRIEF DESCRIPTION OF THE DRAWINGS

FIG. 1 is an example environment of a management system, according to some embodiments.

FIG. 2A is a block diagram of a threshold device, according to some embodiments.

FIG. 2B is a block diagram of the management system, according to some embodiments.

FIG. 3A is an example of votes tallied in relation to a first voting scheme, according to some embodiments.

FIG. 3B is an example of votes tallied in relation to a second voting scheme, according to some embodiments.

FIG. 4A is a flowchart of an example process for creating a group for a secret, according to some embodiments.

FIG. 4B is a flowchart of an example process for revoking a user from a group, according to some embodiments.

FIG. 4C is a flowchart of an example process for reconstituting a secret, according to some embodiments.

FIG. 4D is a flowchart of an example process for using a voting scheme with a plurality of tiers to reconstitute a secret, according to some embodiments.

FIGS. 5A-5B are an interaction diagram illustrating an example process for creating a group, according to some embodiments.

FIGS. 6A-6B are an interaction diagram illustrating an example process for allocating shares to shareholders for an existing group, according to some embodiments.

FIGS. 7A-7B are an interaction diagram illustrating an example process for reconstituting a secret, according to some embodiments.

FIG. 8 is a diagram illustrating an example trusted execution environment voting process for reconstituting a secret, according to some embodiments.

FIG. 9 is a diagram illustrating an example trusted execution environment team formation process, according to some embodiments.

FIG. 10 depicts a diagrammatic representation of a machine in the example form of a computer system, according to some embodiments.

### DETAILED DESCRIPTION

The following disclosure describes embodiments directed to implementing a secret sharing scheme that involve intelligently distributing portions of a secret to different electronic devices. In some embodiments, electronic devices of a defined group each store information that is needed to reconstitute a secret, which may require a threshold number of shares to be reconstituted. Where a threshold number of shares are required for reconstitution, the electronic devices may, for example, be tasked with collectively providing the threshold number of shares to reconstitute the secret. These types of electronic devices, which are responsible for providing shares to meet a threshold, may be referred to herein as “threshold devices.” In some embodiments, the secret sharing scheme allows users to create a group of threshold devices to access shares of a secret and specify a voting scheme that indicates how threshold devices of the group must vote in order for the secret to be reconstituted. The voting scheme may, for example, be individualized and include multiple tiers of threshold devices that vote based on requests for reconstitution. For example, shares of the secret may be distributed to the threshold devices of the group such that the threshold devices each includes the same or varying numbers of shares, and when a user (or an operator) requests for the secret to be reconstituted (e.g., via her/his device, which may be a threshold device, another device associated with the threshold device, or the like), the threshold devices in the group, or their users, may be prompted to vote with an approval or disapproval. In some embodiments, votes include, or are otherwise associated with, shares (e.g., shares associated with the user or her/his threshold device (“user shares”)), and the user shares are associated with respective votes for approval or disapproval, with the shares being tallied against a threshold number of votes required for approval or disapproval. For example, where a vote for approval is submitted via a first threshold device associated with five shares, a vote for approval is submitted via a second threshold device associated with six shares, and a vote for disapproval is submitted via a third threshold device associated with four shares, this may result in a determination of two approval votes and 11 shares for approval, and one disapproval vote and four shares for disapproval. In some embodiments, the secret sharing scheme may require that the secret is reconstituted only if a threshold number of “approvals” are received or a threshold number of “disapprovals” are not received. In some embodiments, the threshold number of approvals/disapprovals (e.g., a threshold number of approvals/disapproval shares) is specified by way of a scheme creation or update process (e.g., conducted by a team or users), which is used to define the voting scheme.

In some embodiments, once approved (e.g., when a threshold number of approvals are received), the threshold device of the user recombines the shares from the vote to reconstitute the secret. In some embodiments, the secret sharing scheme allows users to collectively revoke a threshold device from a group by, for example, creating a new group without the threshold device to be revoked. For example, a threshold number of the threshold devices of the original team may vote to approve formation of a new team without the threshold device to be revoked, and, in response, a new threshold device group may be generated that includes the original set of threshold devices minus the threshold device to be revoked, the old shares may be deleted from the threshold devices in the new group, and a new set of shares may be distributed among the threshold devices of the new group. In such an embodiment, the secret may be split into new shares that are distributed to the threshold devices of the new group, and the secret may be reconstituted using shares from the threshold devices in the new group.

In some embodiments, a threshold device requests certificates for a group of threshold devices to distribute shares of a secret to. For example, a group of threshold devices may be defined, and a threshold device of the group may request certificates of those threshold devices, e.g., for use in certifying the identities of those threshold devices, prior to distributing shares of a secret to those threshold devices. In some embodiments, a manager (e.g., a “dealer” threshold device) generates a group proposal (e.g., specifying member users/threshold devices for the group, initial share distribution, a secret sharing scheme, and so forth). In some embodiments, upon approval of the group proposal, information about the group may be stored, such as member details, share distribution, the secret sharing scheme, and so forth, along with encryption information, such as public/private encryption keys used for encrypted communication with the members. In some embodiments, shares are generated and distributed in accordance with the approved group proposal. For example, the dealer threshold device may split the secret into respective sets of shares to be distributed to the member threshold devices per the group's defined share distribution, encrypt the respective sets of shares for sending to the associated members (e.g., encrypting each set of shares to be sent to a member threshold device using a public/private key scheme associated with the threshold device) to generate encrypted share packets, and send respective encrypted share packets to the associated members.

In some embodiments, a coordination system is operable to coordinate exchanges of information. For example, a threshold device may send a request for a vote (e.g., a vote proposal, proposing a vote to move forward with reconstituting a secret held by the group) to the coordination system, and in response to the coordination system receiving the request, the coordination system sends a request for a vote to each threshold device in the group. Each threshold device may then have an opportunity to submit, to the coordination system, a vote with approval/disapproval, where the vote can include an approval to reconstitute the secret (including one or more of the threshold device's shares for the secret) or vote of disapproval indicating not to reconstitute the secret. Once received, the coordination system may send the votes to the threshold device that requested reconstitution. The threshold device may, in turn, tally the votes/shares received (included with votes) in accordance with the voting scheme defined for the group. Responsive to meeting threshold numbers of approval votes/shares defined by the voting scheme, the threshold device may reconstitute the secret by, for example, recombining the shares received in association with votes of approval.

In some embodiments, a revocation process for a group is conducted in accordance with a revocation procedure defined by a voting scheme for the group. For example, a user of a threshold device may invoke a request to revoke another threshold device from the group associated with the secret. In response to the request, a request for a vote for revocation of the other threshold device may be sent by the threshold device to the other threshold devices in the group, which can individually provide a corresponding responsive vote to the threshold device. The threshold device may, in turn, tally received votes and compare the tally to a critical mass of votes needed for revocation, which may be programmatically specified or specified by the voting scheme. If the tally meets or surpasses the critical mass, the threshold devices of the group may be prompted by the threshold device to send their shares to the requesting threshold device, and the threshold devices may, in turn, send their shares to the requesting threshold device and delete their shares. Using the returned shares, the requesting threshold device may reconstitute the secret, split the secret into new shares, create a new group (excluding the threshold device voted out), and distribute the new shares among the threshold devices of the new group.

In some embodiments, devices participating in a threshold group may be required to support confidential computing and platform attestation. Confidential computing may, for example, include facilitating operations involving a secret or shares of a secret being executed in an environment that is protected from observation by the operator or by external processes. Platform attestation may, for example, include facilitating participating devices to sign data so that other devices, or an external verifier, can confirm that the code and platform executing the protocol are trusted and expected. For example, upon creation of a group, a dealer threshold device may establish a policy that only devices with hardware-based attestation capabilities are permitted to hold or exchange shares. During the group forming process, devices may be assessed to confirm that they meet the policy of hardware-based attestation capabilities. This may include receiving and confirming attestation of capabilities from an attestation certificate provided by the device, a third-party attestation service, or the like. Messages exchanged between confirmed attestation-capable devices of the group may then be platform-attested, enabling each device to validate both the authenticity of the message and the security level of its author. In this way, the system may ensure that shares (and thus secrets) remain safely accessible only within the trusted ecosystem.

In general, attestation may be applied to any communication between devices in the system to ensure that the sending device is operating in a trusted state before its message is accepted. A device may use its hardware-based attestation capability to generate a signed report of its platform state (e.g., firmware version, configuration, or execution environment identity). This report is provided to an audit service or other verifier, which checks the attestation against trusted reference values or certificate authorities. Upon successful verification, the audit service issues a signed attestation record that endorses the device as trusted. That attestation record can then accompany subsequent communications from the device, allowing other devices or operators to verify both the integrity of the device and the authenticity of the message before acting on it. For example, in the context of team formation, such as that described below, when a device generates a team join pledge, it may attach its attestation report. The audit service validates the attestation and signs a confirmation record. When other team members or an operator later receive the pledge, they verify the attached attestation record from the auditor before accepting the pledge as valid. The end user (e.g., an operator) may perform operations such as reviewing the attestation confirmation in a user interface, checking the source and integrity of the pledge, and approving or denying inclusion of the device in the team based thereon. In this way, attestation provides a verifiable chain of trust: the device proves its integrity, the auditor confirms it, and the operator or other devices use that confirmation to decide whether to allow the device's participation. This same approach may be applied to proposals, votes, or distribution of shares, thereby providing a consistent mechanism for authenticating messages and preventing participation by unverified or compromised devices.

Some embodiments may employ a cryptographic bottle (or “bottle”). A bottle may be an encrypted, authenticated container for secure data transport. In some embodiments, some or all of the communication between entities of a trusted execution environment may be accomplished by way of a bottle. For example, communication between threshold devices of a trusted execution environment may include sending data by way of a bottle, which enables a receiving device to authenticate the data. In such an embodiment, e.g., where an authenticated container is used, all communications between entities of a trusted execution environment may be authenticated, facilitating secure and verifiable communications with the environment.

In some embodiments, a request to reconstitute a secret may take the form of proposals. A proposal may be a document that requests reconstitution of the secret and specifies a particular use of the secret once reconstituted. By binding reconstitution to a defined purpose, the proposal may be used to ensure that the secret is not reconstituted in a vacuum but only in the context of an intended operation. For example, a proposal may specify that the reconstituted secret is to be used to digitally sign a contract or to authorize access to a protected account. In such an embodiment, the execution environment that reconstitutes the secret—such as a trusted execution environment (TEE) provided by hardware enclaves executing on the requesting threshold device—may apply the reconstituted secret directly to the requested action, such as generating the digital signature or authenticating to the account, without ever releasing the raw secret to the operator or other devices. In another example, a proposal may request that the secret be used to unlock access to a secure data vault or to approve deployment of a new software build. By constraining access through the secure execution environment, the proposal may ensure that the reconstituted secret can only be used for the specified purpose and cannot be repurposed for unauthorized operations.

In some embodiments, a proposal may also include an ephemeral public key. Votes on the proposal may be encrypted using the ephemeral key (e.g., a private key corresponding to the ephemeral public key), providing forward secrecy because only the execution environment processing the proposal can decrypt the shares contained in the votes using the ephemeral key. Once the proposal has been executed, the execution environment may delete the ephemeral key, ensuring that shares captured in transit cannot be reused. For example, in a proposal to authorize a bank transfer, each threshold device may encrypt its vote using the ephemeral public key included in the proposal, such that only the execution environment for that proposal, which holds the ephemeral key, can decrypt the votes, and once the transfer operation is completed, the execution environment may delete the ephemeral key. In this way, even if an attacker later intercepts the encrypted votes, they cannot be decrypted or reused, since the ephemeral key no longer exists.

In some embodiments, a proposal is a structured request for operations on protected secrets, packaged in cryptographically authenticated containers (or “bottles”) that include various information, such as intent (e.g., a specific operation to be performed (signature generation, decryption, key derivation, etc.) along with the proposer's result-encryption public key), execution context (e.g., metadata binding the intent with vote-encryption keys and execution parameters), target environment (e.g., specification of the trusted execution environment where operations will be performed), or the like.

In some embodiments, proposals may be logged or authenticated by an audit service before execution. For example, operators of threshold devices may be required to submit the authenticated proposal to an audit server so that it can be recorded and made available to protocol participants. In some embodiments, operators may also share a refusal with the audit log, ensuring that negative votes or disapprovals are also captured for accountability.

In some embodiments, the reconstituted secret of a threshold group serves as a root secret from which additional keys are derived. In such embodiments, a threshold device may first circulate a proposal requesting that the group vote to allow reconstitution of the root secret for a specific purpose, such as generating a communication key or producing a new signing key. Only if the voting scheme is satisfied will the threshold devices collectively approve the request and permit the root secret to be reconstituted within the execution environment of the requesting threshold device. The execution environment may then apply the root secret to a key-derivation function to generate one or more “threshold keys,” which are new cryptographic keys bound to the purpose defined in the proposal. For example, in some embodiments, a proposal may request that the root secret be reconstituted in order to derive a communication key for encrypting configuration files. After the group approves the proposal via a vote and the requesting threshold device reconstitutes the root secret, the execution environment of the requesting threshold device may derive the communication key from the reconstituted root secret and immediately apply it to encrypt and authenticate the configuration file, so that only other threshold devices in the group can later decrypt and verify it by way of reconstituting the root secret at the threshold device. In another embodiment, the group may approve a proposal to derive a code-signing key from the root secret, which the execution environment then applies to digitally sign a software release package before it is deployed. In this way, a single group can manage multiple derived secrets for different purposes—such as file exchange, signing, or database access—while maintaining collective control through the proposal and voting process.

In some embodiments, a wrapped threshold key may contain encrypted key material along with another threshold key, where the encrypted material can only be decrypted using the enclosed threshold key. For instance, in some embodiments, a team may protect access to a cloud server by wrapping an SSH private key inside a wrapped threshold key. In this embodiment, the wrapped threshold key contains two components: (i) the encrypted SSH private key material, and (ii) a threshold key recipe specifying that the encrypted material can only be decrypted using a derived key generated from the team's root secret. When a user (e.g., a threshold device) requests to initiate an SSH session, the proposal is circulated to the group of threshold devices. Only if the threshold devices collectively approve the proposal will they effectively cooperate (e.g., via vote) to reconstitute the root secret, which will allow the user to derive the required decryption key using the root secret, and unwrap the encrypted SSH key material using the decryption key. For example, the unwrapped SSH private key may then be provided inside the execution environment of the user (e.g., the requesting threshold device), which can apply it to complete the SSH authentication handshake with the server. At no point is the raw SSH key material released to the user outside of the execution environment. This approach may allow the SSH private key to be usable only with the group's collective approval and helps to prevent any individual from extracting or misusing the credential.

In some embodiments, a coordination service is used to assist in the orchestration of protocol messages between threshold devices. The coordination service may be aware of the protocol and act as a managing intermediary that routes authenticated proposals, votes, and results between devices. For example, when a user initiates a proposal through a web-based interface, the coordination service may forward the proposal to the user's threshold device for authentication, then distribute the authenticated proposal to the other threshold devices in the group, collect their votes, and return the completed vote tallies to the requesting threshold device for execution.

In some embodiments, a convenience store is used to persist non-sensitive information associated with a protected resource, thereby reducing friction for group members working together. For example, if a threshold group is protecting access to a shared cloud infrastructure account, the convenience store may store and make available metadata such as the account identifier, project description, or role assignments for team members, while keeping the sensitive credentials secured by the threshold devices. In another example, if a hospital uses a threshold group to protect access to its electronic health record system, the convenience store may hold non-sensitive details such as patient room numbers, attending physician names, or care team assignments, so that staff can quickly orient themselves. At the same time, sensitive access credentials—such as keys required to view or modify the health records—remain secured by the threshold devices and are only released through the proposal and voting process.

In some embodiments, an auditing service may be used to log and authenticate protocol messages, and in some cases enforce revocations. For example, operators of threshold devices may be required to submit proposals and votes to an audit log, ensuring that every step of the protocol is recorded for accountability. In such embodiments, a negative vote may also be logged, providing participants and regulators with a reliable record of how a particular decision was reached. In another example, a financial institution may use the auditing service to ensure compliance with regulatory requirements for approving large wire transfers. Each proposal to transfer funds, along with the associated votes, may be logged in an immutable record so that internal compliance officers and external regulators can later verify that the transfer was approved by the required parties. Similarly, a software company may require that proposals to release a new software build be logged by the auditing service, ensuring that every approval, disapproval, and abstention is captured before the release proceeds.

In some embodiments, the auditing service may directly enforce revocations by acting as an intermediary for protocol messages. For example, if a proposal or vote is routed through the auditing service, the service may refuse to forward the message if it originates from a revoked device, thereby preventing the revoked device from influencing group decisions. In other embodiments, the auditing service may function primarily as a logging system, while threshold devices themselves enforce revocations. In such embodiments, before accepting a proposal or a vote, a threshold device may require proof from the auditing service (e.g., a signed attestation or an updated revocation list) that the sender is not revoked. For instance, if an employee's laptop serving as a threshold device is reported stolen, the auditing service may issue a signed revocation record, and the other threshold devices may reject any votes from that laptop unless they are accompanied by proof that the revocation has been cleared. In this way, enforcement can be centralized by the audit service or decentralized by the threshold devices, depending on the embodiment.

In some embodiments, a missing piece service may be used to add an additional factor of control over the reconstitution of secrets. In these embodiments, the service maintains a secret value, referred to herein as a “missing piece,” that is not stored on any threshold device and is never included in the team's shares. Even after a successful vote and reconstitution of the root secret, the execution environment of the requesting threshold device may be required to obtain the missing piece from the service. For example, when a group approves a proposal to release funds from a treasury account, the execution environment may first reconstruct the root secret from shares and then request the missing piece from the service. Upon receiving proof that the proposal was properly approved and logged, the missing piece service may provide its secret value, which the execution environment combines with the root secret (e.g., via a key-derivation function) to form the effective key used to authorize the release of funds. Because the missing piece is required in addition to the root secret, even if an adversary were to compromise a threshold of devices and extract all of their shares, the adversary could not use the reconstituted root secret without also interacting with the missing piece service.

Accordingly, in some embodiments, a threshold device of a group or threshold devices issue a request to use a protected secret for a defined operation, a voting scheme is executed to gain input from the group, and if satisfied, the requesting threshold device's secure execution environment (e.g., a TEE on that device) reconstitutes the secret and applies it to an authorized operation (e.g., derive a communication or signing key, or unwrap a protected credential) without exposing raw secret material. In some embodiments, platform attestation and confidential computing restrict participation to trusted devices and enable attested messaging; optional per-request ephemeral keys provide forward secrecy for votes in transit; key derivation lets a single team protect many resources, and optional backing services can assist with orchestration (e.g., coordination), usability (e.g., convenience store), accountability/revocation enforcement (e.g., auditing), and, in some deployments, a final external gate (e.g., missing piece). Such an architecture may mitigate single-party control, reduces risk if a device is compromised, and supports regulatory/audit needs while lowering operational friction.

Although certain embodiments are described through representative context and examples (e.g., document signing, account access, software releases, treasury disbursements, healthcare records) to aid understanding, any suitable context may be used.

The threshold devices, management system, and implementation scheme are further described in detail below.

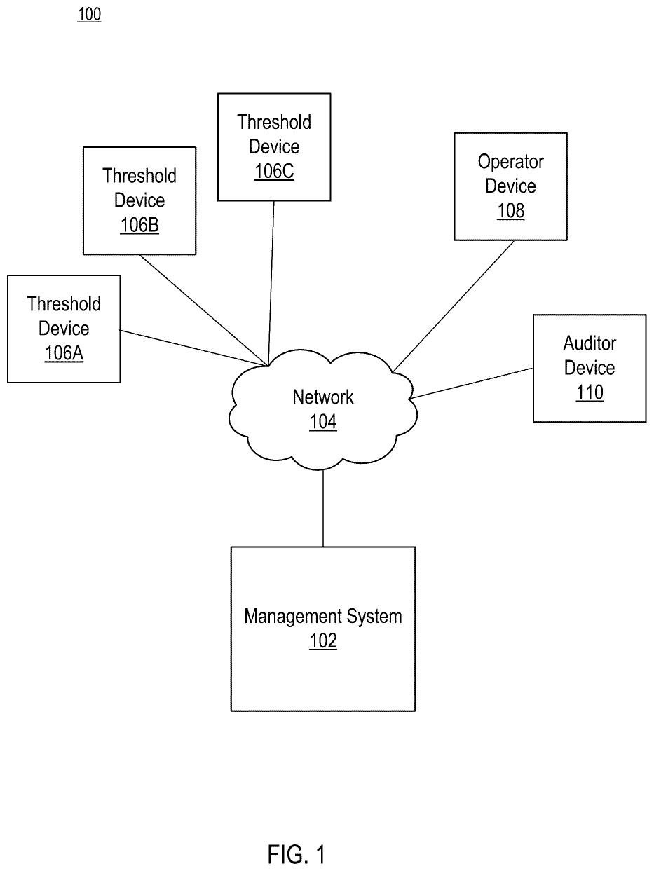

FIG. 1 is an example environment 100 of a management system, according to some embodiments. The illustrated embodiment of the environment 100 includes a management system 102 (e.g., a coordination service or an audit service), a network 104, a plurality of threshold devices 106A-C, an operator device 108, and an auditor device 110. As described, the components of the environment 100, including the management system 102 and threshold devices 106A-C, may be operable to manage the implementation of a secret sharing scheme by facilitating reconstruction of secrets based on communication with each other. In some embodiments, the example environment 100 includes alternative or additional components to those shown in FIG. 1.

In some embodiments, components of the example environment facilitate distributing secrets amongst groups of threshold devices 106A-C. For example, shares of a secret may be distributed across a group of threshold devices 106A-C, which can subsequently provide those shares for reconstitution of the secret. In some embodiments, a secret is information that an operator wants to keep protected without a singular individual having access to the information. For example, a secret may be the passcode to access a bank account of a company, a secret recipe used to make a commercial food product, a combination to a jewelry vault, or the like. In some embodiments, a secret includes highly entropic data. The entropic data may, for example, be the same for a given group, and may be useable to derive keys, sequences, and characters that can in turn be used for data protection and authentication. In some embodiments, a secret includes data defining or regulating performance of a particular action (e.g., an action that the operator does not want a singular individual to have the power to take). For example, a secret may be data defining signing a document, updating a website, changing a password, opening a door, sending a message, and the like. In some embodiments, a threshold device 106A is responsible for splitting the secret into shares, which together comprise the secret. By distributing the shares of the secret to a plurality of threshold devices 106B-C (e.g., such that no one device stores the entire secret), the secret is more secure than if a singular individual or easily accessible hardware device stores the secret in whole.

In some embodiments, the network 104 connects the management system 102 to the threshold devices 106A-C, the operator device 108, or the auditor device 110. In some embodiments, the network 104 is a single network or a plurality of networks 104 that connects some or all of the components of FIG. 1, or other computing devices. The network 104 may be, for example, a personal area network (PAN), local area network (LAN), wide area network (WAN), metropolitan area network (MAN), cellular network, the Internet, etc. Additionally, or alternatively, the management network may employ various communication protocols, such as wired or wireless protocols, which may include long or short-range wireless connectivity technology, such as Bluetooth®, Near Field Communication (NFC), Wi-Fi® Direct (also referred to as “Wi-Fi P2P”), and the like. In some cases, the management system 102 performs a manual exchange of files with the components or through physical (e.g., wired) connection of the components.

In some embodiments, the threshold devices 106A-C communicate with each other by operators (e.g., a computer or person) of the threshold devices 106A-C passing information to one another. The information may include, for example, requests for reconstitution, requests for votes, votes of approval or disapproval, group invitation requests, and group invitations. In some embodiments, the threshold devices 106A-C communicate with the management system 102 to receive a piece for each secret, which may be reconstituted. For example, the piece may be one or more shares of a secret that only the management system 102 has access to, such that a threshold device 106A must request the one or more pieces from the management system to reconstitute the secret. In some embodiments, the management system 102 logs these types of requests, as is described further below.

In some embodiments, the threshold devices 106 store shares of secrets and work in coordination to complete processes for the secret sharing scheme. For example, a set of threshold devices 106 may communicate with one another to distribute shares of a secret therebetween and later communicate with one another to gather the shares to reconstitute the secret for use. In some embodiments, the threshold devices 106A-C are detachably connectable to another hardware device for the purpose of relaying (e.g., transmitting or receiving) information. As an example, a threshold device 106A may be designed and manufactured as a “dongle” that is connectable to a port of a laptop computer or desktop computer. Other examples of threshold devices 106A-C may include other form factors, such as being implemented in an enclave or any other type of device/module that is embedded in a computer. In some embodiments, the threshold devices 106A-C store “shares” of secrets, where each share is a portion of the data that is collectively representative of a secret. In some embodiments, each threshold device 106A-C is required to meet hardware or software standards for implementing a secret sharing scheme. This may be supportive of the premise that a secret is only as secure as the threshold device 106 that stores the secret. For example, if the threshold devices 106A-C were laptops of employees at a company and each stored a share of a secret, an IT administrator at the company may be able to recombine the shares to reconstitute the secret. Thus, for security purposes, each threshold device 106 may be an external device isolated from a computer that can communicate with a virtual machine or other processing entity running the management system 102, to meet hardware standards for implementing a secret sharing scheme.

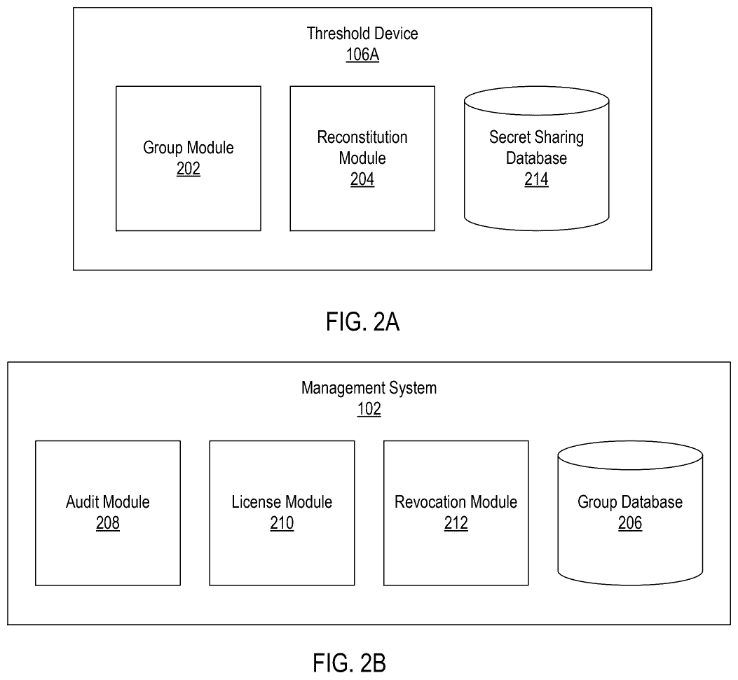

In some embodiments, the threshold devices 106 are operable to communicate via Bluetooth (or another network connection) with a facilitating service, such as the management system 102, or may communicate with the management facilitating services when connected to an external device with access to the network 104 (e.g., a flash drive plugged into a computer). Examples of threshold devices 106A-C include flash drives, Universal Serial Bus (USB) drives, phones or computers not fully accessible by external systems, and the like. For example, in some embodiments, a threshold device 106A may be a laptop that stores password-protected information (e.g., part of a secret) for the management system 102. In such an embodiment, a user may be required to enter the password to access the information, thus protecting information from access by another user not associated with the laptop. Though three threshold devices 106A-C are shown in the embodiment of FIG. 1, embodiments may employ any number of threshold devices 106. Embodiments of the threshold devices 106 are further described in relation to FIG. 2A.

In some embodiments, the management system 102 (e.g., a coordination service) aids the threshold devices 106A-C in facilitating the secret sharing schemes. For example, the management system 102 may store pieces of secrets and related data in association with group information, communicate with the operator device 108 for the threshold devices 106A-C, create certificates that identify threshold devices and/or their users, and communicate pieces of secrets and related data for reconstituting secrets and revoking threshold devices from groups. Embodiments of the management system 102 are further described in relation to at least FIG. 2B.

In some embodiments, the operator device 108 is a computing device that allows an external operator of one or more threshold devices 106A-C to communicate with the management system 102. An operator may, for example, create groups of threshold devices 106A-C that are to be tasked with holding and protecting a secret, as described below) via an operator device 108. The operator device 108 may, for example, be any suitable computing device that connects to the management system 102 via the network 104, such as a laptop, desktop computer, mobile phone, tablet, or threshold device. Though only one operator device 108 is shown in FIG. 1, embodiments may include any number of operator devices 108. In some embodiments, the operator device 108 facilitates communication between the threshold devices 106A-C and the management system 102. In these embodiments, the threshold devices 106A-C may not connect directly to the network 104. For example, they may instead connect directly with the operator device 108.

In some embodiments, interfaces for the components of the example environment 100 are accessible via a web browser, desktop application, mobile application, or over-the-top (OTT) application. For example, a user may be able to access interfaces that are designed to guide her/him through a session in which predetermined physical activities (e.g., exercises) are to be performed a predetermined number of times via a mobile application that is executing on a mobile phone or tablet computer. As another example, a coach may be able to access interfaces through which she/he can review the progress of one or more users via a web browser executing on a tablet computer or laptop computer. As another example, a coach may be able to access interfaces through which she/he can personalize users'sessions based on, for example, their needs and progress. Accordingly, the interfaces for the system may be viewed on various computing devices depending on the nature of the pose monitoring platform 102 and its deployment. Examples of computing devices include desktop computers, laptop computers, tablet computers, mobile phones, wearable electronic devices (e.g., watches or fitness accessories), mobile workstations (also referred to as “computer carts”), network-connected electronic devices (e.g., televisions or home assistant devices), and virtual or augmented reality systems (e.g., head-mounted displays).

FIG. 2A is a block diagram of a threshold device 106A, according to some embodiments. In the illustrated embodiment, the threshold device 106A includes a group module 202, a reconstitution module 204, and a secret sharing database 214. In some embodiments, the threshold device 106A includes alternative or additional modules or databases to those shown in FIG. 2A.

In some embodiments, the group module 202 is operable to distribute shares of a secret to a group of threshold devices 106B-C. The group module 202 may, for example, receive a request, input via an interface at the threshold device 106A, to distribute a secret. The request may, for example, include the secret, one or more threshold devices 106B-C to which to distribute shares of the secret to (referred to as the “group” associated with the secret), and a voting scheme for the secret. In some embodiments, the request is associated with one or more users (e.g., rather than the one or more threshold devices 106B-C) and one or more operator devices 108. However, for simplicity, the groups may be described in relation to threshold devices 106B-C herein. For example, a request of the threshold device 106A may be a request initiated or transmitted by the threshold device 106A or a user/operator of the threshold device 106A. In some embodiments, the voting scheme includes one or more tiers of threshold devices 106B-C that are allowed to vote to reconstitute the secret. Each tier may, for example, be associated with one or more subsets of threshold devices 106B-C, and each subset may, for example, be associated with a threshold number of shares that must be received with votes of approval for the secret to be reconstituted. In some embodiments, the voting scheme also includes identifiers of threshold devices 106B-C not specified in the voting scheme that are permitted to request reconstitution of the secret. In some embodiments, the group module 202 sends the voting scheme for approval to an operator or to the threshold devices 106A-C for the group. Embodiments of the voting scheme are further described in relation to the reconstitution module 204 below.

In some embodiments, the request includes characteristics of users identified in the request. Characteristics may include, for example, the user's role within an organization, security available at the user's threshold device 106A-C, tasks the user performs in relation to the group (e.g., management, engineering, etc.), and the like. For example, a request asking to distribute a secret among Marianne, Melissa, Stacy, and Evelyn may indicate that Marianne and Evelyn are nurses, Melissa is a doctor, and Stacy is a hospital floor manager. In some embodiments, the group module 202 stores the voting scheme in association with an identifier of the secret (e.g., a designated name or number) and the one or more threshold devices 106B-C (or users) in the secret sharing database 206. The group module may also send this information for storage at the group database 206 of the management system 102.

In some embodiments, the group module 202 splits the secret of the request into shares. The shares may, for example, be portions of the secret that, when recombined, create the secret. Each share may, for example, be cryptographically protected such that only a reconstitution module 204 at a threshold device 106A-C can decrypt the share using a key associated with the share. The share may, for example, be encrypted against certificates of threshold devices 106B-C and/or characteristics not associated with the share and is associated with identities and/or characteristics of users of the threshold devices 106B-C to be allotted with the share. In some embodiments, the group module 202 splits the secret into shares to match the voting scheme associated with the request. For example, the group module 202 may split the secret into enough shares for each threshold device 106B-C of the group, each role of users associated with the group, or for each tier of users to have the same number of shares as the threshold number. For example, group module 202 may split a secret into one share for allocation to Melissa and two shares for allocation to nurses associated with the group of threshold devices 106B-C. In some embodiments, some shares are distributed to multiple threshold devices 106B-C, and some threshold devices 106B-C are allotted multiple shares. The group module 202 may, for example, associate each share with an identifier of the secret, its key, and an identifier of the tier and/or subset of the threshold devices 106B-C in the voting scheme associated with the share.

In some embodiments, the group module 202 creates a piece for the secret that only the management system 102 stores. The piece may be, for example, a share or a zero-knowledge piece that allows a device to reconstitute the secret when the device also has all of the necessary shares. In some embodiments, the group module 202 sends the piece to the management system 102 for storage in the group database 206 with the other information related to the group.

In some embodiments, the group module 202 sends a request to the management system 102 to determine whether each threshold device 106B-C of the group has been verified for use in relation to the management system 102. The group module 202 may, for example, receive, from the management system 102, a certificate created to identify each threshold device 106B-C. Each certificate may also identify a user of the threshold device 106B-C. In some embodiments, the group module 202 also receives certificates for threshold devices 106B-C already associated with the management system 102 from the management system 102. In some embodiments, the group module 202 creates the certificates. The group module 202 may, for example, associate one or more shares of the secret designated for a threshold device 106B with the certificate. In some embodiments, the group module 202 distributes each certificate with its shares to the threshold device 106B. For example, group module 202 may send the certificate over the network 104 to the threshold device 106B. As another example, the group module 202 sends the certificate to the threshold device 106B in response to receiving an indication that the threshold device 106B is connected to the threshold device 106A via a direct (e.g., wired) connection.

In some embodiments, where a request indicates one or more users for a group, the group module 202 creates a certificate identifying a threshold device 106, an associated user, and her/his characteristics for each user not already associated with a threshold device 106 associated with the management system 102. For example, if Marianne does not have a threshold device 106A logged in the group database 206 of the management system, the group module may create a certificate identifying Marianne and indicating that her/his role is a nurse at Silicon Valley Hospital. The group module 202 may, for example, associate the certificate with a share designated to be distributed to Marianne. In some embodiments, the group module 202 associates the certificate with a share designated to be distributed to a nurse (e.g., Marianne's role). Upon receiving an indication from the operator device 108 that a threshold device 106B to be associated with Marianne is connected to the management system 102, the group module 202 may, in turn, distribute the certificate to the threshold device 106B. After distribution, the threshold device 106B may be prohibited from being associated with another user without being completely reset, which would remove the certificate and any shares of the secret designated to Marianne stored at the threshold device 106B.

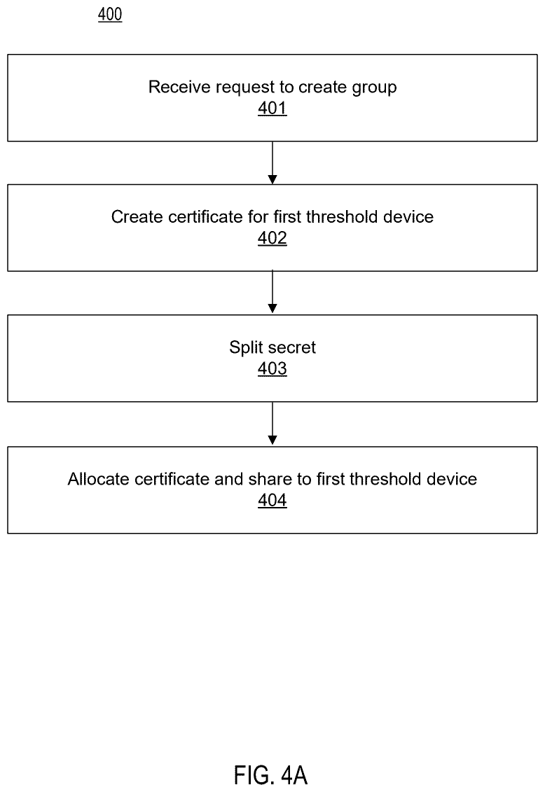

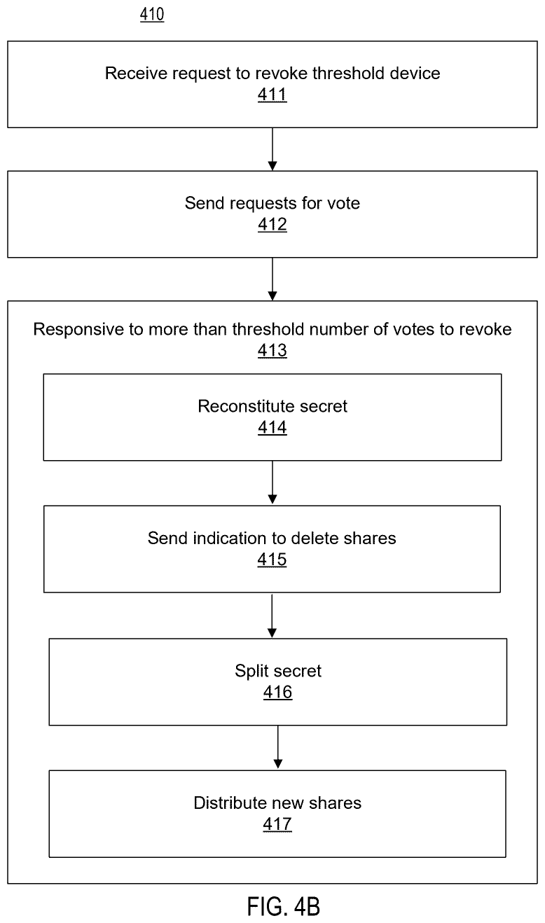

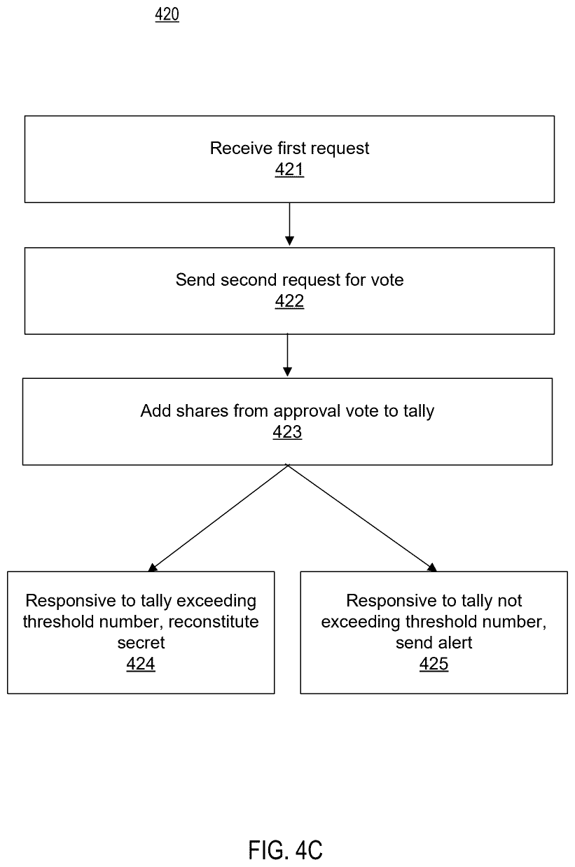

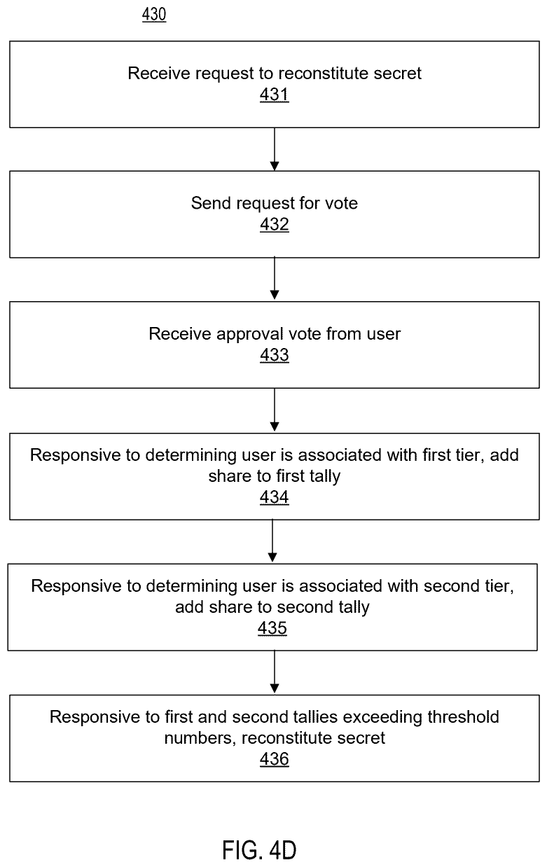

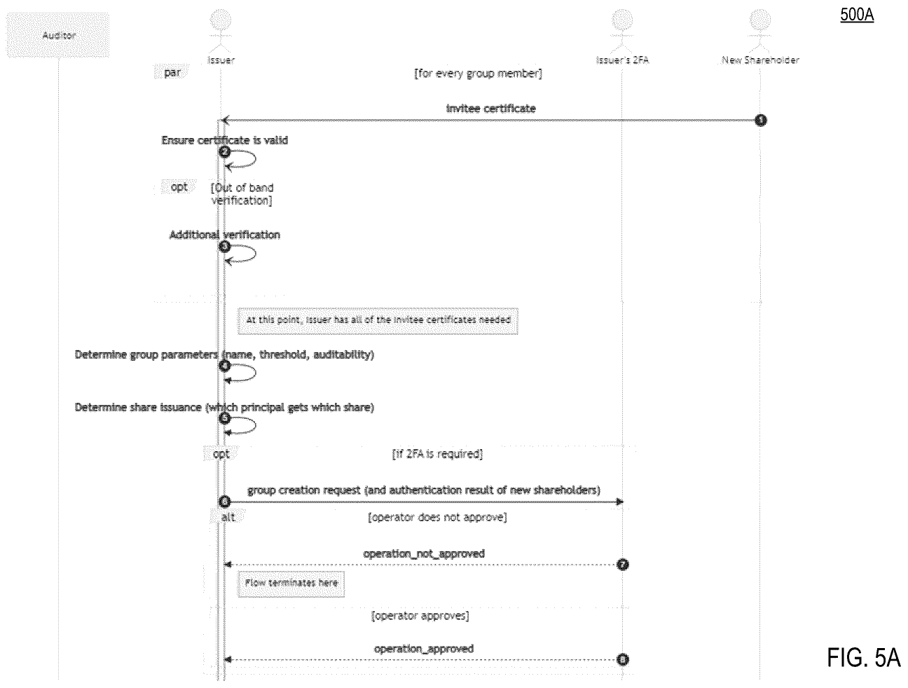

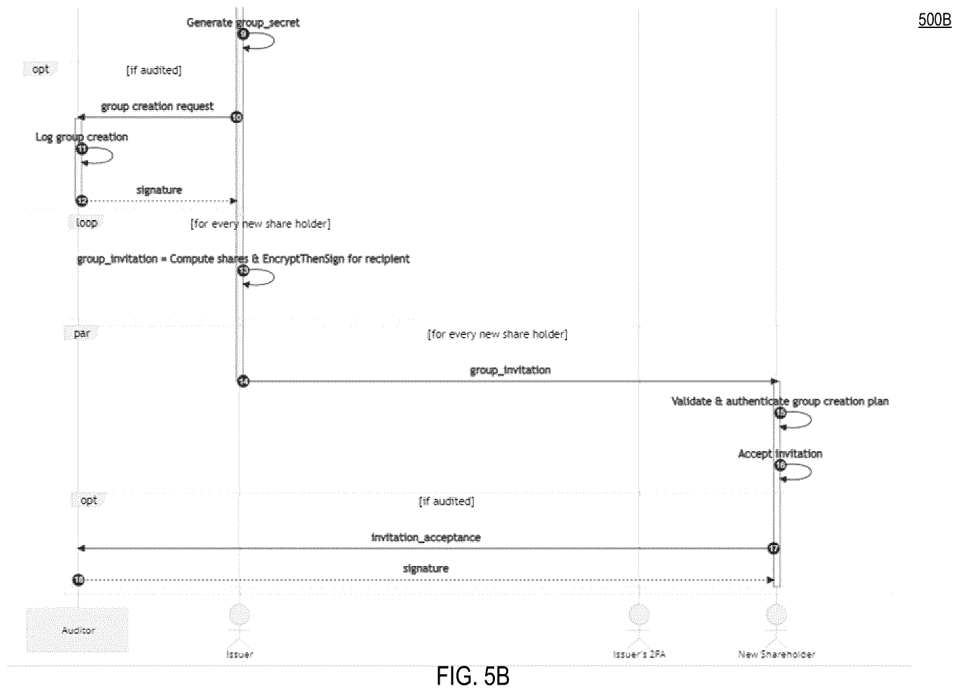

Additional processes for group creation performed by the group module 202 are described in relation to at least FIG. 4A, FIGS. 5A-5B, and FIGS. 6A-6B and FIG. 9.

In some embodiments, the group module 202 processes requests to revoke threshold devices 106B-C from groups. For example, the group module 202 may receive a request from a threshold device 106A to revoke another threshold device 106B from a group including both threshold devices 106A-B. In some embodiments, the group module 202 receives the request from an operator device 108. In some embodiments, the request specifies the identifier of the threshold device 106A and/or its user, which the group module 202 uses to access an associated voting scheme and characteristics about the user. In some embodiments, the request also specifies an identifier of the secret related to the voting scheme. The group module 202 may, for example, determine threshold devices 106B-C in the group associated with the voting scheme by accessing the secret sharing database 214 or requesting the information from the management system 102. The group module 202 may, for example, request, from each threshold device 106 in the group, a vote of whether or not to revoke the other threshold device 106B. In some embodiments, the group module 202 only sends the request to the threshold devices 106 that are within the same tier as the other threshold device 106B. The group module 202 may, for example, send the requests to the threshold devices 106 of the group via direct (wired) connections, via the network 104, or through the management system 102.

In some embodiments, the group module 202 receives votes from the threshold devices 106A-C and compares the number of shares associated with votes indicating approval to a revocation threshold. The revocation threshold may be the number of shares from votes indicating approval for revocation that the group module 202 must receive to revoke the user. In some embodiments, the revocation threshold is also representative of the number of shares needed to reconstitute the secret. If the number of shares in votes indicating approval do not meet or surpass the revocation threshold, the group module 202 may keep the group as-is in the secret sharing database 214. In some embodiments, if the group module 202 determines that the number of votes indicating disapproval meets or surpasses a second revocation threshold, the group module 202 keeps the group as-is in the secret sharing database 214. In some embodiments, if the number of shares in votes of approval do meet or surpass the revocation threshold, the group module 202 creates a new group associated with the identifier of the secret. In these instances, the group module 202 may reconstitute the secret using the shares from the votes indicating approval and split the reconstituted secret into a new set of shares. The group module 202 may redistribute shares in the new set among threshold devices 106A-C of the new group including the threshold devices 106A-C from the previous group, other than that of the threshold device 106B being revoked. In some embodiments, the group module 202 stores the new group with the voting scheme (minus the role of the user/threshold device 106B that was revoked) in the secret sharing database 214 and/or the group database 206 in association with the identifier of the secret and a version of the group. For example, the new group may be a second version of the group, where the previous group (e.g., including the revoked user) is a first version of the group.

In some embodiments, a similar process to that described above with respect to revocation may be used to add new threshold devices 106 to a group associated with a secret. For example, the group module 202 may receive a request from a threshold device 106B to add a threshold device 106C to a group. The group module 202 may, in turn, access a voting scheme associated with the group and send a request for a vote to include the new threshold device 106C to threshold devices 106 associated with the group. The group module 202 may then tally shares from votes indicating approval received from the threshold devices 106 and compare the tally to an inclusion threshold, which indicates the number of shares needed to reconstitute the secret and make the new group. In some embodiments, if the tally meets or surpasses the inclusion threshold, the group module 202 reconstitutes the secret using the shares from the votes of approval. In some embodiments, the group module 202 also tallies votes indicating disapproval and does not reconstitute the secret if the tally meets or exceeds the threshold. The group module 202 may, for example, create a new group including the threshold devices 106 associated with the previous group and the new threshold device 106C, add the new threshold device 106C to the voting scheme of the previous group, split the secret into a new set of shares for the new group, and distribute shares of the new set to the new group. The group module 202 may store the new group with the voting scheme in the secret sharing database 214 and/or send the voting scheme to the management system 102 for storage in association with the identifier of the secret and a version of the group.

In some embodiments, the reconstitution module 204 reconstitutes secrets from shares distributed among threshold devices 106A-C. For instance, the reconstitution module 204 may receive a request to reconstitute a secret. The request may, for example, be from the operator device 108 or from a threshold device 106A that has been allocated a share of the secret. In some embodiments, the reconstitution module 204 accesses the group database 206 (or sends a request to the management system 102) to retrieve a voting scheme associated with an identifier of the secret. The voting scheme may, for example, indicate a tier of one or more threshold devices 106A-C from the group associated with the secret who may vote regarding reconstitution of the secret. The tier may, for example, include one or more subsets of threshold devices 106A-C from the group, where each subset of threshold devices 106A-C may be associated with users that have particular identities and/or characteristics. In some embodiments, the voting scheme further specifies, for each subset, a number of shares related to the subset that must be received for the secret to be reconstituted. For example, the voting scheme for releasing a patient's medical records may indicate that Melissa, who is the patient's doctor, and Evelyn, who is the patient's nurse, must both approve a request to release the patient's medical records. In another example, the voting scheme for discharging a patient may indicate that one floor manager and two nurses must approve a request to discharge a patient.

In some embodiments, the voting scheme for a secret is multi-tiered. In such embodiment, it may be required that the request be approved at every tier for the secret to be reconstituted. In some embodiments, the tiers must be approved in a particular order. For instance, the tiers may be ordered based on a hierarchy at a company, where a tier including threshold devices 106A-C of users who are low in the hierarchy (e.g., software engineers) must gain approval before a tier with threshold devices 106A-C of users who are higher in the hierarchy (e.g., directors, vice presidents, members of the C-suite, etc.). For example, a voting scheme for a request to reset a password of a threshold device 106B of a chief executive officer (CEO) may indicate that the CEO must request the reset (via her/his threshold device 106B) and two directors (first tier) must approve the request via their threshold device 106 for the request to be sent to the threshold device 106 of a chief financial officer (CFO) and/or chief operating officer (COO) (second tier), one of whom must approve the request at his threshold device 106 in order for the CEO's password to be reset.

In some embodiments, the reconstitution module 204 determines an identifier of the device that sent the request for reconstitution. For instance, the reconstitution module 204 may query the device for an identifier or access the identifier associated with the device from the secret sharing database 214 or the management system 102. In some embodiments, the reconstitution module 204 determines whether the device associated with the identifier is allowed to request reconstitution of the secret. For instance, if the device is not part of the voting scheme or identified in relation to the voting scheme as allowed to request reconstitution, the reconstitution module 204 determines that the secret may not be reconstituted in response to the request. In some embodiments, the reconstitution module 204 determines if the device is included in a most recent version of the group of threshold devices 106A-C associated with the voting scheme. In these embodiments, even if the device is included with a previous version of the group, the reconstitution module 202 may determine that the secret may not be reconstituted if the device is not associated with the most recent version of the group. The reconstitution module 204 may, in some instances, send an indication to the device that the request is denied.

In some embodiments, the reconstitution module 204 sends requests for votes based on the voting scheme. For example, the reconstitution module 204 may send a request for a vote to each threshold device 106A-C of the group associated with the identifier of the secret. In embodiments where the voting scheme is multi-tiered, the reconstitution module 204 may first send requests for votes to the threshold devices 106A-C in subsets associated with a first tier of the voting scheme. In embodiments where the voting scheme requires an approval from an operator, the reconstitution module 204 may send a request for approval to an operator device 108 associated with the identifier of the secret when requesting votes from a tier of the operator device 108.

In some embodiments, the reconstitution module 204 receives votes from the threshold devices 106A-C. Each vote may indicate whether the user of the associated threshold device 106A approves or disapproves of reconstitution of the secret. In some embodiments, the vote may further indicate whether a user abstains from responding to the request for the vote or whether the user's vote is contingent upon a set of criteria. The set of criteria may, for example, indicate one or more other threshold devices 106A-C that must also approve reconstitution for the user's vote to count, that the request for reconstitution sent to the reconstitution module 204 must have come from a specific threshold device 106, that external data about a company reach a particular threshold, and the like. For example, a first threshold device 106A may vote to approve reconstitution only if a second threshold device 106B and a third threshold device 106C also approve reconstitution. In another example, the user of the first threshold device 106A may vote to approve reconstitution only if her/his company's stock is below a threshold number. In yet another example, the user may vote to disapprove of reconstitution if the vote is requested in the fourth quarter of the calendar year.

In some embodiments, the reconstitution module 204 tallies the shares of votes indicating approval received from the threshold devices 106A-C at each tier in the voting scheme. In some embodiments, the reconstitution module 204 receives multiple shares votes from a single threshold device 106A. In these embodiments, the user of the threshold device 106A may be allotted multiple shares of the secret, giving the threshold device 106A user the power to send multiple shares with votes indicating approval. For each tier, the reconstitution module 204 may compare the tally to the threshold number specified in the voting scheme as needed for the secret to be reconstituted. The reconstitution module 204 may also compare tallies for each subset to a number of shares needed for the subset. Once the votes at a tier or subset have met or surpassed its associated threshold number specified in the voting scheme, the reconstitution module 204 may determine that the tier or subset has approved reconstitution. In some embodiments, if all of the tiers and subsets have approved reconstitution, the reconstitution module 204 creates a pre-secret including all of the shares. If not, the reconstitution module 204 does not create a pre-secret. In some embodiments, if the number of votes indicating disapproval meets or surpasses a disapproval threshold at a tier or subset, then the reconstitution module 204 also does not create the pre-secret. If the tallies fall short, the module may deny the request.

In some embodiments, the reconstitution module 204 sends an indication that the pre-secret has been made to the management system 102. The reconstitution module 204 may receive a piece for the secret from the management system 102. In embodiments where the voting scheme is multi-tiered, the reconstitution module 204 may request a piece for each tier or subset of the voting scheme from the management system 102. In these embodiments, even if all other threshold devices 106A-C of a tier vote to approve reconstitution, the reconstitution module 204 may not be able to reconstitute the secret with the piece for the tier. In some embodiments, the reconstitution module 204 uses the pre-secret (e.g., the received shares) and critical pieces received from the management system 102 to reconstitute the secret.

In some embodiments, the reconstitution module 204 performs one or more actions based on the secret. For example, the secret may be information that the reconstitution module 204 sends for display (e.g., via a graphic user interface, referred to as a GUI) at the device that requested the reconstitution (e.g., a threshold device 106A or an operator device 108). In another example, the reconstitution module 204 may send the secret to one or more designated devices and/or parties. In some embodiments, the secret is related to one or more pieces of code or logic that is executed using information from the secret once the secret is reconstituted. In these embodiments, the reconstitution module may send the votes in relation to the one or more pieces of code or logic such that users can approve/disapprove reconstitution of the secret based on whether the users want the one or more pieces of code or logic to be executed. In some embodiments, the reconstitution module 204 executes the piece of code or logic if the threshold number of shares are received with the votes. For example, if a piece of code that describes a digital signature is approved through the votes, the reconstitution module 204 may create a digital signature with the secret or digitally sign a document or other file based on the secret.

In some embodiments, the secret is data that defines, causes, or allows an action to occur. For example, reconstitution may result in unlocking access to an account (such as changing a password), approving a document, signing a document, opening a safe, unlocking a door, and any other applicable action. In some embodiments, if the reconstitution module 204 determines that a secret may not be reconstituted (e.g., too many users voted against reconstitution or did not vote in response to the request), the reconstitution module 204 sends an alert via a GUI to the device that requested reconstitution or an associated operator device 108. The reconstitution module 204 may also log that a vote regarding the secret failed to pass in association with the identifier of the secret and a time and date that the vote failed in the secret sharing database 214 or may send this information to the management system 102 for logging.

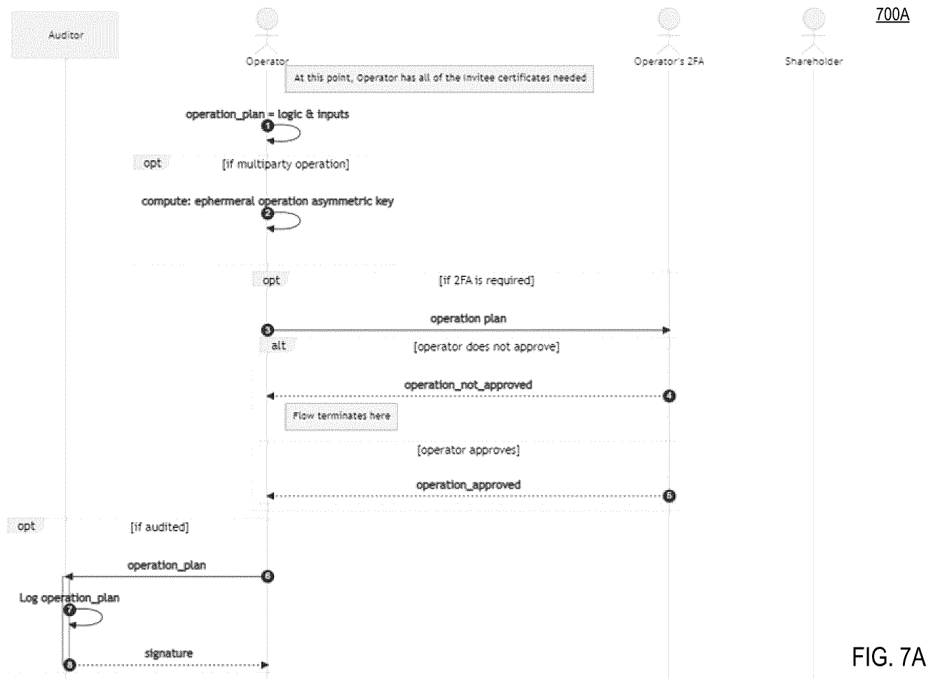

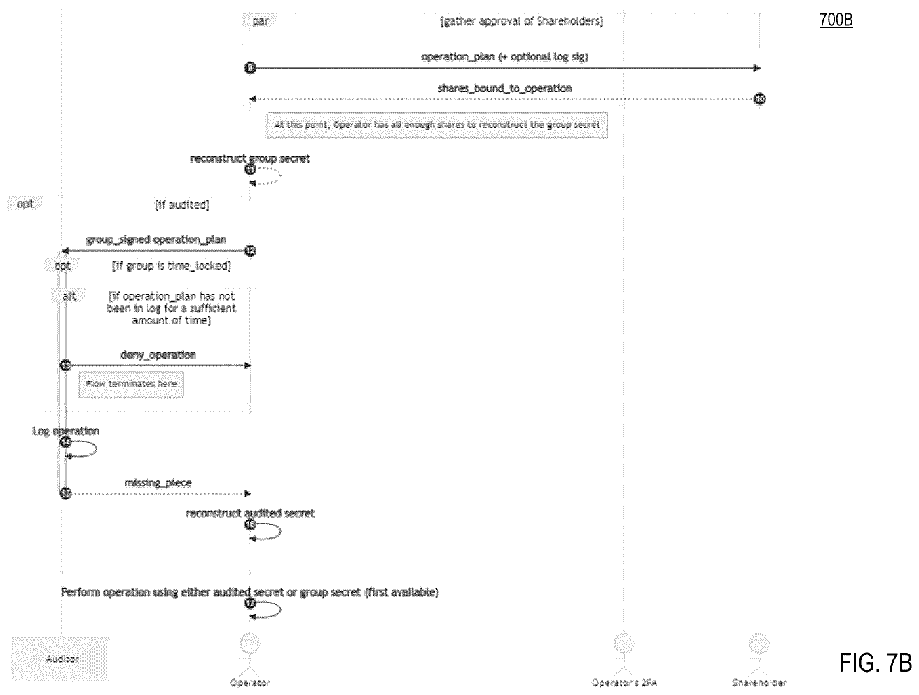

Additional processes for group creation performed by the revocation module 204 are also described in relation to at least FIGS. 7A-7B.

FIG. 2B is a block diagram of the management system 102 (e.g., a coordination service), according to some embodiments. The illustrated embodiment of the management system 102 includes an audit module, a license module 210, a revocation module 212, and a group database 206. In some embodiments, the management system 102 includes alternative or additional modules or databases to those shown in FIG. 2B.

In some embodiments, the audit module 208 performs actions related to group creation and secret reconstitution executed by threshold devices 106A. The audit module 208 may, for example, log group creation requests received from an operator device 108 or threshold device 106A-C in the secret sharing database 214. The audit module 208 may, for example, store an identifier of a secret in association with identifiers of threshold devices 106A-C in a group for the secret, a voting scheme, characteristics of users associated with the threshold devices 106A-C, a critical piece, and the like in the group database 206. In some embodiments, the audit module 208 accesses information in the group database 206 in response to requests from threshold devices 106A-C and operator devices 108 (e.g., for revocation, secret reconstitution, etc.) and sends the information accordingly. The audit module 208 may, for example, update the information when a new group is created (e.g., by creating a new version, removing a threshold device 106, etc.) and when one or more threshold devices 106A-C are added to groups.

In some embodiments, during secret reconstitution, the audit module 208 sends information to a requesting device for facilitating a vote. When the requesting device sends an indication that a pre-secret has been created, the audit module 208 logs that the secret has been approved for reconstitution, along with one or more of a time, a date, which threshold devices approved/disapproved/abstained during voting, an identifier of the requesting device, and the like in association with an identifier of the secret in the group database 206. The audit module 208 accesses the piece for the secret and sends the piece to the requesting device.

In some embodiments, the license module 210 licenses devices to access the logs of secrets that have been reconstituted from the group database 206. The license module 210 receives, from an operator device 108, a request for an authorization token for a secret, an identifier of a device that will receive the authorization token, and a time period that the authorization token should provide access to the log for. The license module 210 mints an authorization token based on requesting a vote from threshold devices 106A-C associated with the secret. If a threshold number of votes indicate approval, the license module mints the authorization token and sends the authorization token to the operator device 108 or to the device specified by the identifier in the request. When the license module 210 receives the authorization token from the device within the time period, the license module 210 accesses the log in the group database 206 and sends information from the log to the device.

In some embodiments, the revocation module 212 aids devices during revocation of group members. For example, the revocation module 212 may receive a request for a vote from a device (e.g., an operator device 108 or a threshold device 106A-C). The request may include an identifier of a secret, which the revocation module 212 uses to access a voting scheme for the secret in the group database 206. The revocation module 212 may send requests for votes to the threshold devices specified in the voting scheme and pass votes back to the device. In some embodiments, the revocation module 212 may send identifiers of one or more of the threshold devices 106A-C to the device such that the device can request and receive the votes. In these embodiments, the device may send identifiers of the threshold devices 106A-C that responded to the revocation module 212, which determines whether any of the votes came from threshold devices 106A-C not associated with the most recent version of the group. If a threshold device 106A-C is not associated with the most recent version, the revocation module 212 may send an indication to the device indicating so.

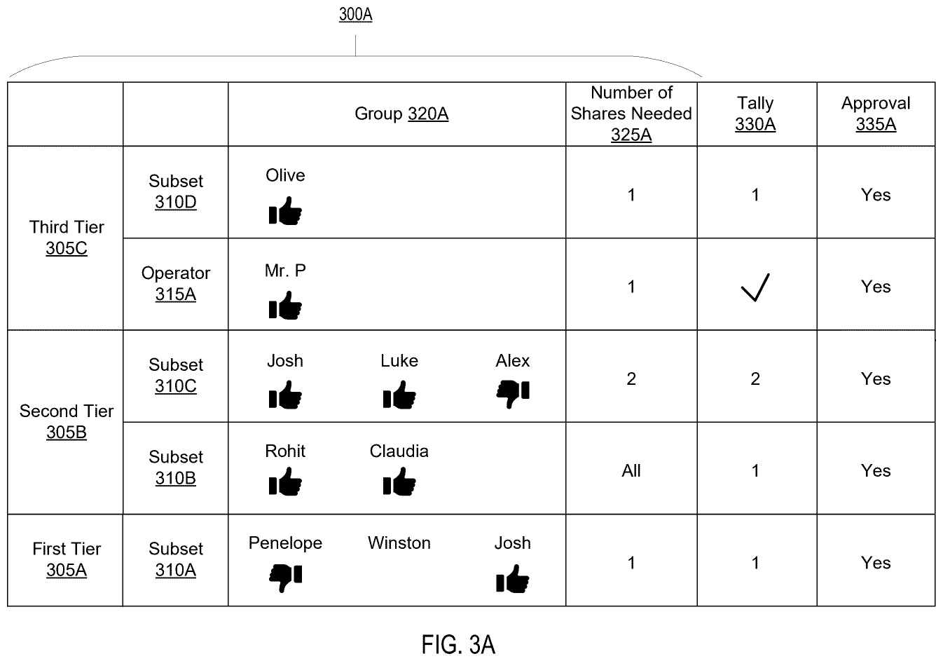

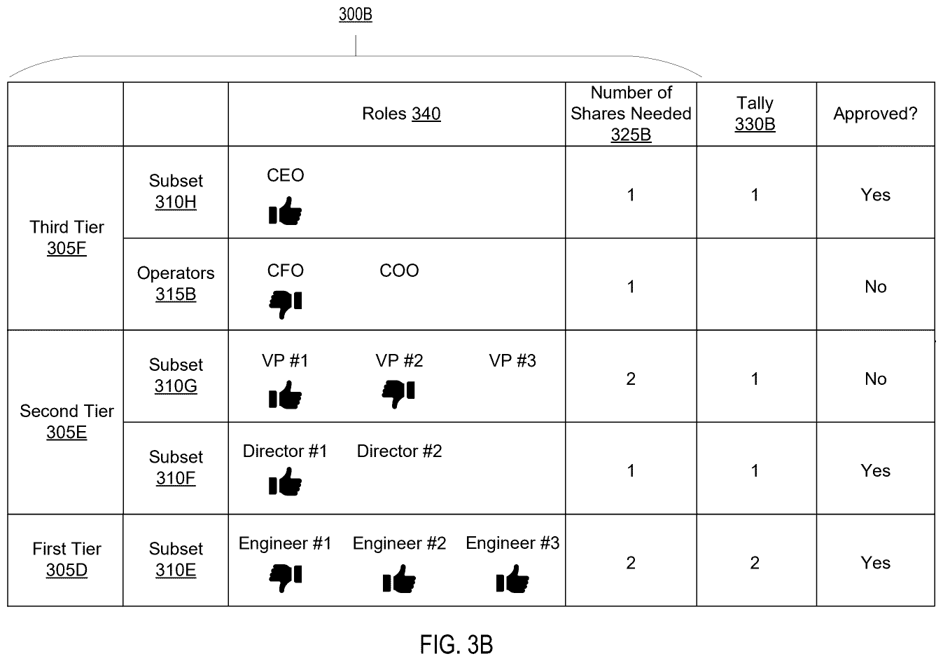

FIG. 3A is an example of votes tallied in relation to a first voting scheme 300A for a secret, according to some embodiments. The voting scheme 300A may, for example, be specified by an operator upon request to distribute shares of the secret amongst a group 320 of users. The group 320 of users is split into three tiers. The first tier 305A includes subset 310A of the group 320 of users (e.g., Penelope, Winston, and Josh). The second tier 305B includes subset 310B (e.g., Rohit and Claudia) of the group 320 and subset 310C (e.g., Josh, Luke, and Alex). As shown, Josh is included in subset 310A and subset 310C. Thus, when Josh votes in relation to the first voting scheme 300A, his vote is tallied in relation to both subsets 310A and 310C. In some embodiments, Josh enters one vote in relation to each subset 310A and 310C. The third tier 305C includes subset 310D (e.g., Olive) and an auditor 315A (e.g., Mr. P). The voting scheme 300A may specify to collect votes for each tier and subset 310 sequentially, starting with the first tier 305A and subset 310A. In other embodiments, the voting scheme 300A specifies to request votes from all users in the group 320 at once. In these embodiments, the tiers 305 and subsets 310 are used to group users in relation to the threshold number of shares from votes needed 325A for approval of a request to reconstitute the secret.

In some embodiments, the reconstitution module 204 tallies shares based on received votes from the group 320, for example, as shown in the column of tallies 330A. In this example, assume that each vote is associated with a single share. Each tally 330A has surpassed the number of shares needed 325A for approval at each tier 305 and subset 310. For example, even though Alex voted against reconstitution in subset 310C, the tally 330A still surpassed the number of shares needed 325A since Luke and Josh both voted to approve. In another example, though Winston did not vote and Penelope voted against reconstitution in subset 310A, the tally 330A still surpassed the number of shares needed 325A because Josh voted with approval. Further, the operator 315A (Mr. P) approved reconstitution. Since the subsets 310 each reached approval 335A and the operator 315A also approved reconstitution, the reconstitution module 204 reconstitutes the secret based on the shares.

FIG. 3B is an example of votes tallied in relation to a second voting scheme 300B for a secret, according to some embodiments. Again, assume that each vote is associated with a single share. Though shown in relation to roles 340 of users, the voting scheme 300B may be based on other characteristics of users in other embodiments. The voting scheme 300B is split into three tiers. In other embodiments, the voting scheme 300B may include any number of tiers 305, and each tier 305 may include any number of subsets 310 and operators 315. The first tier 305D includes subset 310E users with the role 340 of engineer. The second tier 305E includes subset 310F of users within the group with the role of director and subset 310G of users with the role of vice president (e.g., VP). The third tier 305C includes subset 310H of users with the role of CEO, which is only one user since the company using the voting scheme 300B only has one CEO, and two operators 315B, one with the role 340 of CFO and one with the role 340 of COO. The voting scheme 300B may specify to collect votes for each tier and subset 310 sequentially, starting with the first tier 305D and subset 310E or with the third tier 305F and the auditors 315B or any other location within the voting scheme 300B. In other embodiments, the voting scheme 300B specifies to request votes from all users in the group at once. In these embodiments, the tiers 305 and subsets 310 are used to group users in relation to a threshold number of shares needed 325B for approval of a request to reconstitute the secret.

In some embodiments, the reconstitution module 204 tallies shares based on votes received from the users fulfilling the roles 340 specified by the voting scheme 300B. In this example, the tally 330B for the first tier 305D surpassed the number of shares needed 325B to reconstitute the secret, even though one of the engineers voted against reconstitution. The tallies 330B for subset 310F and subset 310H also surpassed the number of votes needed 325B, even though one director voted against reconstitution. However, the request for reconstitution failed at subset 310G, where only one VP voted for reconstitution, while the other two VPs either voted against reconstitution or abstained from voting. Further, the request failed to gain approval from the operators 315B, one of whom needed to approve the reconstitution for the request to be approved. In some embodiments, all operators in a tier 305 may need to approve reconstitution for the request to be approved.

FIG. 4A is a flowchart of an example process 400 for creating a group for a secret, according to some embodiments. In particular, the process may include the group module 202 receiving a request to create a group for a secret (block 401). The request may include a voting scheme and a plurality of threshold devices 106A-C (e.g., the group) to each receive a share of the secret. The group module 202 may, for example, receive the request from a threshold device 106A or an operator device 108. The group module 202 may, for example, send a request for approval of the voting scheme and the threshold devices 106A-C of the group to each threshold device 106A-C specified in the request to create the group and only proceed with creating the group if one or more of the threshold devices 106A-C send approval. The process may include the group module 202 creating a certificate for a first threshold device 106A of the group not already associated with the management system 102 (block 402) and splitting the secret into a plurality of shares and a “critical”piece (block 403).

The process may include the group module 202 allocating the certificate and a share to the first threshold device 106A (block 404). In some embodiments, allocating the certificate to the first threshold device 106A is responsive to receiving, from an operator device 108, verification that the first threshold device 106A is associated with the first user. In some embodiments, when the reconstitution module 204 receives a request for a vote related to the first threshold device 106A, the reconstitution module 204 sends a request for a vote to the first threshold device 106A and other threshold devices 106B-C associated with the secret. The request for the vote may be displayed via a GUI at the first threshold device 106A (or, in some embodiments, at a connected external device that includes a display system). Responsive to receiving, from the first threshold device 106A, a vote indicating approval of reconstitution, the reconstitution module 204 may increase a tally of shares associated with the voting scheme by a number of shares associated with the vote from the first threshold device 106A. Responsive to the tally of votes exceeding a threshold number, the reconstitution module 204 may reconstitute the secret by combining the first user's share with other shares received in votes from the threshold devices 106 and a critical piece stored at the management system 102.

In some embodiments, the example process of FIG. 4A includes additional or alternative steps to those shown in FIG. 4A. For instance, in some embodiments, the certificate may be encoded with one or more roles of the user associated with the first threshold device 106A, and the tally may be associated with a first role. Further, the group module 202 may encrypt the share using a key associated with the share.

FIG. 4B is a flowchart of an example process 410 for revoking a threshold device 106B from a first group associated with a secret, according to some embodiments. In particular, the process may include the group module 202 receiving a request to revoke access to a secret for a threshold device 106B in a first group of users (block 411). The group module 202 may send, to the threshold device 106 of each user in the first group of users other than the threshold device 106B, a request for a vote to revoke the threshold device 106B from the group (e.g., the user's access to the secret) (block 412). Responsive to more than a threshold number of threshold devices 106 of the first group voting to revoke the threshold device 106B (block 413), the group module 202 may reconstitute the secret (block 414), send an indication to each threshold device 106 of the group (other than threshold device 106B) to delete its share of the secret (block 415), split the secret into new shares for the second group (block 416), and distribute the new shares to the threshold devices 106 of the first group other than threshold device 106B (e.g., the second group) (block 417).

In some embodiments, the example process of FIG. 4B includes additional or alternative steps to those shown in FIG. 4B. For instance, in some embodiments, the first group is associated with a first version and the second group is associated with a second version. Responsive to receiving a first request to reconstitute the first version of the secret, the reconstitution module 204 may deny the request. Responsive to receiving, from a threshold device 106C, a second request to reconstitute the second version of the secret, the reconstitution module 204 may send a request for a vote to reconstitute the secret to the threshold devices 106 in the second group.

FIG. 4C is a flowchart of an example process 420 for reconstituting a secret, according to some embodiments. In particular, the process may include the reconstitution module 204 receiving a first request to reconstitute a secret (block 421). The reconstitution module 204 may send, to a set of threshold devices 106, a second request for a vote to reconstitute the secret (block 422). The reconstitution module 204 may receive, from a first threshold device 106A, a vote indicating approval from a first user associated with the first role, the reconstitution module adds shares of the vote to a tally associated with the first role (block 423). Responsive to the tally exceeding a threshold number, the reconstitution module 204 may reconstitute the secret by recombining shares of the secret and a critical piece stored by the management system 102 (block 423). Responsive to the tally not exceeding the threshold number, the reconstitution module 204 sending, to an operator device 108, an alert that the vote did not pass (block 425).

In some embodiments, the example process of FIG. 4C includes additional or alternative steps to those shown in FIG. 4C. For example, in some embodiments, the reconstitution module transmits, to the first threshold device 106A, a GUI with interactive elements that allow the first user to select between the approval, disapproval, and an option to abstain. The GUI may include a request for a passcode that the first user must enter to vote. In some embodiments, the voting scheme specifies a second threshold number of votes of approval needed to reconstitute the secret, where votes from threshold devices associated with users of a second role count towards the second threshold number. In other embodiments, the reconstitution module 204 performs one or more other actions, such as logging, in response to the tally not exceeding the threshold number.

FIG. 4D is a flowchart of an example process 430 for using a voting scheme with a plurality of tiers to reconstitute a secret, according to some embodiments. For instance, the process may include the reconstitution module 204 receiving a first request to reconstitute a secret (block 431). The secret may be associated with a voting scheme, and the voting scheme specifies a group of users (or in some embodiments, threshold devices 106A-C) that includes a first tier and a second tier. The reconstitution module 204 sends, to a threshold device 106 of each of the group of users, a second request for a vote to reconstitute the secret (block 432). The reconstitution module 204 receives a first vote indicating approval from a first threshold device 106A (block 433). In some embodiments, receiving the positive vote includes receiving an electronic signature from the first threshold device 106A, receiving a notification that the second request was logged, or receiving a password associated with the first threshold device 106A.

In some embodiments, responsive to determining that a first user of the first threshold device 106A is associated with the first tier, the reconstitution module 204 adds shares from the first vote indicating approval to a first tally associated with the first tier (block 434). Responsive to determining that the first user of the first threshold device is associated with the second tier, the reconstitution module 204 adds shares from the first vote indicating approval to a second tally associated with the second tier (block 435). Responsive to the first tally exceeding a first threshold number and the second tally exceeding a second threshold number, the reconstitution module 204 reconstitutes the secret (block 436).

In some embodiments, the example process of FIG. 4D includes additional or alternative steps to those shown in FIG. 4D. For example, in some embodiments, the first tier includes a first subset and a second subset, and the first tally includes a first sub-tally and a second sub-tally. In these embodiments, responsive to determining that the first user is associated with the first subset, the reconstitution module 204 may add the positive vote to the first sub-tally. Further, responsive to determining that the first user is associated with the second subset, the reconstitution module 204 may add the positive vote to the second sub-tally.

FIG. 5A-5B are interaction diagrams 500A and 500B illustrating example processes 500 for creating a group, according to some embodiments. The actors of the processes 500 may be, for example, an auditor (e.g., the management system 102, such as a coordination service), an issuer (such as an operator or other user of the management system 102), the issuer's two-factor authentication system, and a new shareholder (e.g., a user in a group responsible for maintaining a secret). Though some actors are described as the individuals themselves (e.g., the issuer or the user), the interactions may be performed by computing devices operated by the individuals (e.g., threshold devices 106A-C, operator device 108, etc.). In some embodiments, the example process is completed without the interactions related to the auditor and/or the two-factor authentication. The interaction diagrams 500A and 500B may represent interactions that may take place for every user of a group that the issuer creates for a secret.

In some embodiments, first, the new shareholder provides an invitee certificate to the issuer. The invitee certificate may identify the user, and the issuer may ensure the invitee certificate's validity. In some instances, out-of-band verification (e.g., external verification by an actor not shown in FIG. 5A-5B) is used to verify the invitee certificate. Once the issuer has all of the invitee certificates for users of the group for the secret, the issuer determines a set of parameters for the group. The parameters may include a name of the group, a voting scheme, a threshold number of shares needed to reconstitute the secret, auditability of the group, and the like. The issuer determines which shares of the secret to issue to each user of the group and sends a group creation request to the two-factor authentication system. If the group creation request is not approved, the example process ends.

In some embodiments, if the group creation request is approved, the issuer generates the secret and sends a group creation request to the auditor. The auditor logs the creation of the group in a record database and provides a signature to the issuer representing their approval of creation of the group. For every user in the group, the issuer computes a share of the secret and encrypts the share for the user. The issuer sends an invitation for the group to each user, and the user (e.g., new shareholder in FIG. 5B) validates and authenticates the group creation plan and accepts the invitation. The user stores their share at their threshold device 106. The user sends an indication of their acceptance to the auditor, who provides a signature to the user to verify that their inclusion in the group has been logged.

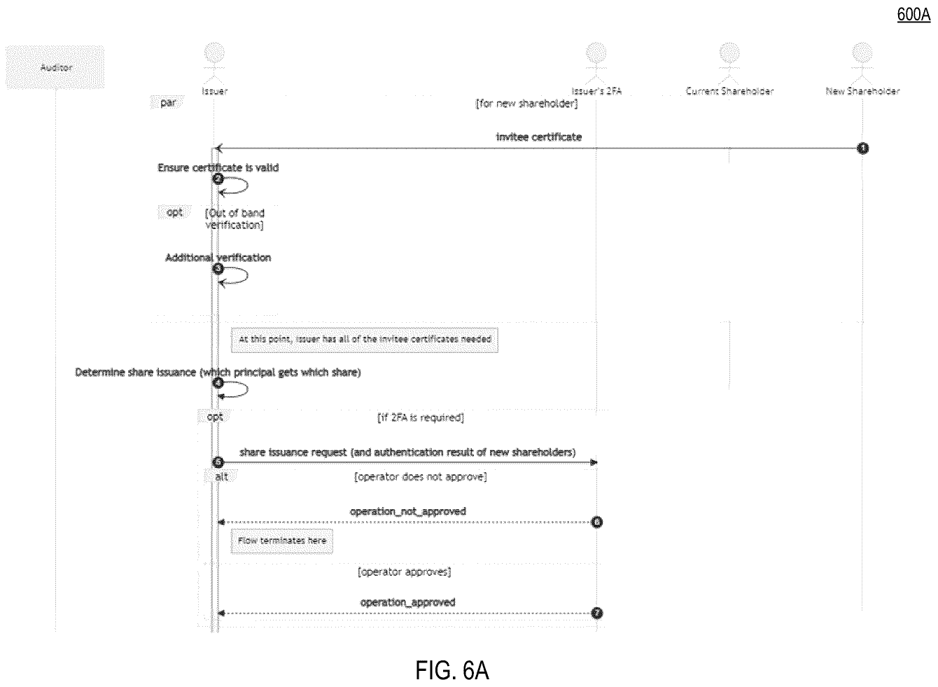

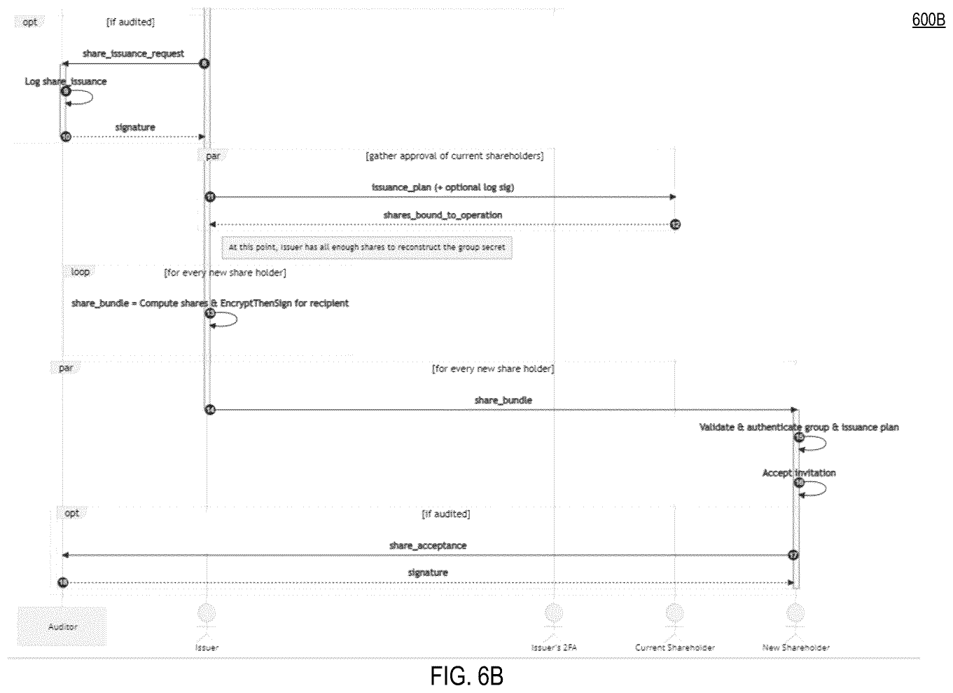

FIG. 6A-6B are interaction diagrams 600A and 600B illustrating an example process for allocating shares to shareholders for an existing group 600, according to some embodiments. The actors of the processes 600 may be, for example, an auditor (e.g. the management system 102, such as a coordination service), an issuer (such as an operator or other user of the management system), the issuer's two-factor authentication system, a current shareholder (e.g., a first user), and a new shareholder (e.g., a second user). Though some actors are described as the individuals themselves (e.g., the issuer or the first and second users), the interactions may be performed by computing devices operated by the individuals (e.g., threshold devices 106A-C, operator device 108, etc.). In some embodiments, the example process is completed without the interactions related to the auditor and/or the two-factor authentication. The interaction diagram 600 may represent interactions that may take place to mint shares for users in a group associated with a secret.

In some embodiments, first, the new shareholder provides an invitee certificate to the issuer. The invitee certificate may identify the second user, and the issuer may ensure the invitee certificate's validity. In some instances, out-of-band verification (e.g., external verification by an actor not shown in FIG. 5A-5B) is used to verify the invitee certificate. Once the issuer has all of the invitee certificates for users of the group for the secret, the issuer determines how to issue the shares among the group. The issuer sends an issuance request and an authentication of the second user for inclusion in the group. If the group creation request is not approved, the example process ends.

In some embodiments, if the group creation request is approved, the issuer generates the secret and sends a group creation request to the auditor. The auditor logs the creation of the group in a record database and provides a signature to the issuer representing their approval of creation of the group. The issuer gathers approval of current shareholders of the group, such as the first user, regarding the issuance plan to issue a share to the second user. The issuer may log signatures from the current shareholders and receive the shares of the secret from the current shareholders. The issuer creates a new group for the secret. For instance, for every shareholder (e.g., the users in the original group, including the first user, and the second user), the issuer computes a share and encrypts the share for the shareholder. The issuer sends the new shares via an invitation for the new group to each associated shareholder in the new group, including the second user. The second user validates and authenticates the new group and the issuance plan and accepts the invitation for joining the group and the share (stored at the second user's threshold device 106). The second user sends an indication of their acceptance to the auditor, which provides a signature to the user to verify that their inclusion in the group has been logged.

FIG. 7A-7B are interaction diagrams 700A and 700B illustrating an example process 700 for reconstituting a secret, according to some embodiments. The actors of the process 700 may be, for example, an auditor (e.g., the management system 102, an operator, the operator's two-factor authentication system, and a shareholder (e.g., user)). Though some actors are described as the individuals themselves (e.g., the operator or the user), the interactions may be performed by computing devices operated by the individuals (e.g., threshold devices 106A-C, operator device 108, etc.). In some embodiments, the example process is completed without the interactions related to the auditor and/or the two-factor authentication.

In some embodiments, the operator creates an operation plan and computes an asymmetric key for the operation plan. The operator sends the operation plan to the two-factor authentication and the example process terminates if the two-factor authentication system does not approve the operation plan. If approved, the operator sends the operation plan to the auditor. The auditor logs the operation plan in a record database and provides a signature to the operator representing their approval of the operation plan. The operator gathers approval of the users of the group (e.g., requests votes from the users) to reconstitute the secret and receives the shares from the users that approved reconstitution, provided tallies associated with a voting scheme of the secret exceeded associated threshold numbers. The operator reconstructs the secret with the shares.

In some embodiments, the operator sends the operation plan as signed by the users (via their approval) to the auditor, which approves or denies the operation plan. If denied, the example process terminates and the secret is not fully reconstituted. If approved, the auditor logs the approval of the operation plan and sends approval of reconstitution, which may be a critical piece of the secret necessary for reconstitution. The operator fully reconstructs the secret based on the missing piece from the auditor. In some embodiments, the operator does not reconstruct the secret until approval has been received from the auditor, even if all of the shares needed to reconstitute the secret have been received. The operator performs an operation using the secret (either with the auditor approval or without the auditor's approval in embodiments without an auditor). For example, the operation may be an action, such as providing a signature, opening an enclosure, releasing a passcode, and the like, or may be information the operator wanted for activities external to the management system 102.

The implementation of the secret sharing schemes described here may remedy at least some of the drawbacks of conventional secret sharing systems. For example, the use of a secure management system and threshold devices may help to ensure that no external individual or entity has access to a secret during splitting or to all shares of a secret at one time. Thus, for example, an IT manager may not access shares via employees'laptops or even directly from the management system. The secret sharing schemes may also remove the ability of an individual to make themselves the only user in a group (and thus have control over a secret) since, for example, the entire group may be required to vote collectively on whether to revoke or include users from the group. This may also allow the group to collectively maintain access to the secret, such that the secret is not in danger of exposure if a share is stolen from one of the users. As another example, the secret sharing scheme may help to reduce practical difficulties experienced by conventional systems by using a secure management system 102 that protects reconstituted secrets and its methods of reconstitution from external access.

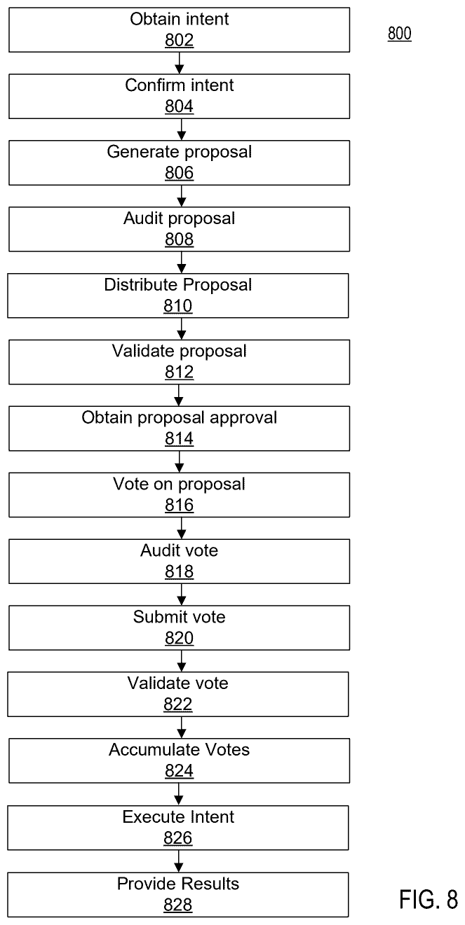

FIG. 8 is a diagram illustrating an example trusted execution environment voting process 800 for reconstituting a secret, according to some embodiments. This may provide, for example, a secret-based operation execution in a trusted execution environment. Operations of the process 800 may be performed by, for example, one or more of the management system 102, threshold devices 106A-C, operator device 108, an operator (e.g., a user person or user system), an operator's two-factor authentication system, and a shareholder (e.g., user), or another entity.

In some embodiments, process 800 includes obtaining intent (block 802). This may include an execution environment, such as a first threshold device, receiving or otherwise identifying an intent that specifies an operation to be executed within a trusted execution environment. The intent may, for example, include a structured request specifying a desired operation (e.g., an action, such as signature generation, decryption, key derivation, etc.) to be executed within the trusted execution environment. For example, obtaining an intent may include the threshold device 106A receiving, from a developer workstation (a proposer device), an intent of “Deploy Release Package v2.3” to threshold device 106A, where the threshold device 106A is to act as the execution environment within a trusted execution environment that includes multiple threshold devices (threshold device 106A-106D), which each store shares of a root secret for use in execution of an operation in the trusted execution environment.

In some embodiments, process 800 includes confirming intent (block 804). This may include an optional review to confirm the obtained intent. Continuing with the prior example, confirming the intent may include the threshold device 106A converting the received intent into readable text “Proposed action: Deploy Release Package v2.3 to production cluster,” and displaying the text via graphical user interface, for review by a human or system operator, where the operator provides confirmation (e.g., selects to approve) or does not provide confirmation (e.g., makes no selection or selects to disapprove). As described, the threshold device 106A may, for example, proceed with generating a proposal responsive to receiving operator confirmation of the intent.

In some embodiments, process 800 includes generating proposal (block 806). This may include generating a proposal that includes the intent, along with an identifier of the proposal, and one or more cryptographic keys for use in encrypted communication with the trusted execution environment. The proposal may, for example, be provided in the form of a bottle (e.g., an attested bottle), as described here. For example, responsive to confirmation of an intent, the execution environment may assign a unique identifier to the proposal, generate an encrypted receiver key pair that includes a private receiver key and a corresponding public receiver key, and package (e.g., in an attested proposal bottle) the proposal identifier, the intent, and the public receiver key, securely storing the private key for use (e.g., the private key being deleted when the proposal is resolved). Continuing the prior example, generating a proposal may include the threshold device 106A assigning a proposal identifier (PROP-RELEASE-2023-09), generating a receiver key pair (RXKEY-PRV-001: RXKEY-PUB-001), generating a package (e.g., a bottle) that includes the proposal identifier (PROP-RELEASE-2023-09), the public receiver key (RXKEY-PRV-001: RXKEY-PUB-001), and the intent “Deploy Release Package v2.3 to production cluster”, and storing the receiver private key (RXKEY-PRV-001) locally.

In some embodiments, process 800 includes auditing proposal (block 808). This may include auditing the proposal to ensure it satisfies audit criteria and, when satisfied, providing an attestation that is indicative thereof. Such an audit may be conducted by a third-party audit service. Also, the attestation may accompany the proposal to enable the receiving party to validate the proposal or its sender. Continuing with the prior example, auditing the proposal may include the threshold device 106A providing the proposal (e.g., the proposal bottle) to the audit device 110, and the audit device 110 confirming the credentials of the threshold device 106A, and, in turn, logging the proposal identifier (PROP-RELEASE-2023-09) in its ledger and returning, to the threshold device 106A a proposal attestation (e.g., a signature) (AUD-SIG-123) to accompany the proposal, for authenticating the proposal.

In some embodiments, process 800 includes distributing proposal (block 810). This may include sending the proposal to team member devices of the trusted execution environment. The team member devices may include a group of threshold devices of the trusted execution environment storing shares of a root secret for use in execution of an operation in the trusted execution environment. As described, the team member devices may be a group capable of voting to approve the proposal, and provide shares of a root secret that can be reconstituted by the execution environment, to provide the root secret for use in enabling execution of the intent. Continuing with the prior example, distributing the proposal may include the threshold device 106A sending the proposal, a package (e.g., an attested proposal bottle with the proposal attestation (AUD-SIG-123) that includes the proposal identifier (PROP-RELEASE-2023-09), the public receiver key (RXKEY-PRV-001: RXKEY-PUB-001), and the intent “Deploy Release Package v2.3 to production cluster,” to each of team member devices 106B, 106C, and 106D, which store shares of a root secret needed for execution of the intent in the trusted execution environment, and are capable of voting to approve the proposal and providing the shares for reconstitution into the root secret. In some embodiments, the proposal is distributed by a third party, such as the audit service, a coordinator, or the like. For example, the audit device 110 may distribute the proposal to the team member devices 106B, 106C, and 106D, along with an attestation of the proposal. The resulting packet may be referred to as an attested proposal (e.g., an attested proposal bottle).

In some embodiments, process 800 includes validating proposal (block 812). This may include a recipient of a proposal validating that the proposal is appropriate for use in a voting scheme. For example, validating the proposal may include verifying the authenticity of the proposal, conducting policy checking of the approval, or the like. Continuing with the prior example, validating the proposal may include device 106B (and some or all of the other team member devices 106C and 106D) verifying that the signature (AUD-SIG-123) is valid, which indicates that the proposal was generated by trusted execution environment of device 106A, and that it is running approved release firmware, or the like, or otherwise validating the source of the proposal. Continuing with the prior example, validating the proposal may include device 106B (and some or all of the other team member devices 106C and 106D) conducting policy checks to confirm that the proposal meets team policy requirements (e.g., defined team attributes). The team policy requirement may, for example, include “Only allow deployment proposals signed by Release Manager group,” and if device 106B determines that the audit signature (AUD-SIG-123) indicates that the proposal is signed by a member of the Release Manager group, here device 106A, it may, in turn, approve the proposal. In some embodiments, obtaining proposal approval is a final approval conducted in response to initial approval of the proposal based on initial policy checks. A similar set of operations may be conducted for each of the other team member devices 106C and 106D.

In some embodiments, process 800 includes obtaining proposal approval (block 814). This may include querying an operator for approval of the proposal intent. Continuing with the prior example, obtaining proposal approval may include device 106B (e.g., responsive to validation of the proposal) displaying the proposal (or a corresponding operational intent of the proposal), such as “Proposal: Deploy Release Package v2.3 to production cluster” via a graphical user interface, and prompting the operator for approval/disapproval of the proposal. This provides the operator with an opportunity to submit an approval/disapproval decision for the proposal presented. A similar set of operations may be conducted for each of the other team member devices 106C and 106D.

In some embodiments, process 800 includes voting on proposal (block 816). This may include, responsive to approval or disapproval of a proposal, submission of a corresponding vote to the execution environment. An approval vote may, for example, be provided in the form of a bottle (e.g., an attested bottle), as described here. For example, responsive to receipt of an approval decision, a threshold device storing a subset of shares of the root secret, may encrypt the subset of shares of the root secret using the public key earlier received via the proposal, to generate an encrypted set of shares, and package (e.g., in an attested vote bottle) the proposal identifier and the encrypted set of shares. Continuing with the prior example, voting on the proposal may include device 106B, in response to an approval decision for the proposal, encrypting the subset of shares of the root secret using the public receiver key (RXKEY-PRV-001: RXKEY-PUB-001), to generate an encrypted set of shares, and creating an approval vote (e.g., an approval vote bottle) having an identifier (VOTE-RELEASE-01), and including the identifier (PROP-RELEASE-2023-09), and the encrypted set of shares. A similar set of operations may be conducted for each of the other team member devices 106C and 106D.

In some embodiments, process 800 includes auditing vote (block 818). This may include auditing the vote to ensure it satisfies audit criteria and, when satisfied, providing an attestation that is indicative thereof. Such an audit may be conducted by a third-party audit service. Also, the attestation may accompany the vote to enable a receiving party to validate the vote or its sender. Continuing with the prior example, auditing the vote may include the threshold device 106B providing the approval vote (e.g., the approval vote bottle) to the audit device 110, and the audit device 110 confirming the credentials of the threshold device 106B, and, in turn, logging the vote identifier (VOTE-RELEASE-01) in its ledger and returning, to the threshold device 106B a vote attestation (e.g., a signature) (AUD-VOTE-SIG-01) to accompany the vote, for authenticating the vote. A similar set of operations may be conducted for each of the other team member devices 106C and 106D.

In some embodiments, process 800 includes submitting vote (block 820). This may include submission of a vote from some or all of the team members to the execution environment. Continuing with the prior example, submitting the approval vote (e.g., the approval vote bottle (VOTE-RELEASE-01)) to threshold device 106A. In some embodiments, a vote is submitted by a third party, such as the audit service, a coordinator, or the like. For example, the audit device 110 may send the approval vote bottle) (VOTE-RELEASE-01) to threshold device 106A, along with an attestation of the approval vote. The resulting packet may be referred to as an attested vote (e.g., an attested vote bottle). A similar set of operations may be conducted for each of the other team member devices 106C and 106D.

In some embodiments, process 800 includes validating vote (block 822). This may include the execution environment verifying the validity (e.g., authenticity, provenance, or policy compliance) of the vote received. This may include, for example, a receiving threshold device verifying cryptographic attestation, ensuring the threshold device satisfies team policy, verifying an audit attestation signature, or the like. Continuing with the prior example, validating the vote may include device 106A verifying authenticity of the vote the approval vote (VOTE-RELEASE-01) having the identifier (PROP-RELEASE-2023-09), by confirming that the audit attestation signature (AUD-VOTE-SIG-01) is valid, which indicates that the proposal bottle was generated by trusted execution environment 106B, and that it is running approved release firmware, or the like, or otherwise validating the source of the vote. In some embodiments, accumulation of a vote is conducted in response to validation of the vote. A similar set of operations may be conducted for votes received from each of the other team member devices 106C and 106D.

In some embodiments, process 800 includes accumulate votes (block 824) and execute intent (block 826). This may include the execution environment logging and counting approval/disapproval votes and comparing the total number of approval/disapproval votes to associated approval/disapproval vote thresholds, and, once sufficient votes are received for approval, the execution environment reconstructing the root secret and executing the intent using the root secret. For example, this may include decrypting shares of approval votes, determining whether a sufficient number of shares associated with approval votes to satisfy a voting shares threshold has been received, and, in response to determining the satisfaction of the voting shares threshold, reconstructing the root secret in response to the, deriving deployment key(s) using the root secret, and executing the proposal intent using the deployment key(s), and securely deleting the receiver key pair after deriving deployment keys or executing the intent. Continuing with the prior example, vote accumulation may include device 106A, decrypting shares of the encrypted shares provided in the approval vote provided by device 106B (and potentially 106C and 106D) to determine a number of approved shares, determining that the number of approved shares satisfies the voting shares threshold for the trusted execution environment, and in response, conducting an intent execution that includes, reconstructing the root secret (ROOT-DEPLOY-KEY) using the decrypting shares, deriving a cryptographic code-signing key (KEY-SIGN-REL23) using the root secret, and signing Release Package v2.3 for deployment using code-signing key (KEY-SIGN-REL23). In some embodiments, secret reconstruction may require external piece. For example, an execution environment may combine shares with a missing piece obtained from a service (e.g., a missing piece service, as described here). Continuing with the prior example, device 106A may request “MISSING-DEPLOY-PIECE” from a missing piece service, combine it with the root secret (ROOT-DEPLOY-KEY), and use the combination to derive the code-signing key (KEY-SIGN-REL23).

In some embodiments, process 800 includes providing results (block 828). This may include delivering an indication of results. For example, the execution environment may provide confirmation or resulting artifact to the proposer/operator. Continuing with the prior example, providing results may include threshold device 106A returning confirmation: “Release v2.3 successfully signed and deployed,” to the proposer's workstation, where it is displayed to the proposer. In some embodiments, actions may be undertaken based on the confirmation. For example, in response to the indication that “Release v2.3 successfully signed and deployed,” the proposer's workstation may send an instruction to cause installation of software deployment Release v2.3 on various workstations, Release v2.3 may be archived in its current form for use/reference, or the like.

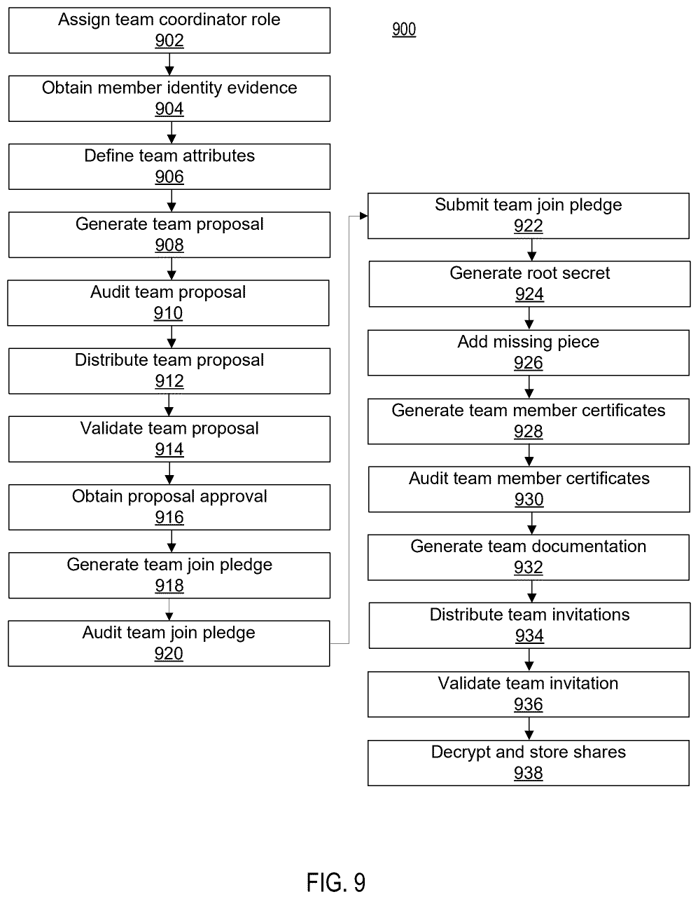

FIG. 9 is a diagram illustrating an example trusted execution environment team formation process 900, according to some embodiments. This may provide, for example, formation of a trusted execution environment. Operations of process 900 may be performed by, for example, one or more of the management system 102, threshold devices 106A-C, operator device 108, an operator (e.g., a user person or user system), an operator's two-factor authentication system, and a shareholder (e.g., a user), or another entity.

In some embodiments, process 900 includes assigning dealer role (block 902). This may include an execution environment device assuming the role of team coordinator (or “dealer”) to coordinate team creation. The role may be specified, for example, by a team specification that identifies a team of threshold devices to form or otherwise define a trusted execution environment, identifying a given one of the threshold devices as a team coordinator device (a “dealer”), and identifying the others of the threshold devices as team member devices. For example, assigning dealer role may include threshold device 106A receiving (e.g., from management system 102 or another entity), determining, or otherwise obtaining a team specification that designates devices 106A-106D as the team member devices of a “Release Management Team” responsible for approving and deploying software releases, and identifying the first threshold device 106A as a team coordinator device, and identifying the other threshold devices 106B-106D as team member devices. The team member devices may include a group of threshold devices of the trusted execution environment intended for storing shares of a root secret for use in execution of an operation in the trusted execution environment. As described, the team member devices may be a group capable of voting to approve the proposal, and to provide shares of a root secret that can be reconstituted by the execution environment, to provide the root secret for use in enabling execution of the intent.

In some embodiments, process 900 includes obtaining member identity evidence (block 904). This may include the team coordinator device receiving (e.g., from a threshold device, management system 102 or another entity), device identity evidence. This may include a device identifier (e.g., a unique identifier of the threshold device), a device attestation (e.g., an attestation of the threshold device), or the like. The device identity evidence may, for example, be provided in the form of a bottle (e.g., an attested device identity evidence bottle), as described here. Continuing with the prior example, obtaining member identity evidence may include sending a request for member identity evidence to each of candidate devices 106B, 106C, and 106D (e.g., by management system 102 or another device), and each of candidate devices 106B, 106C, and 106D generating and transmitting to device 106A, device identity evidence (e.g., in an attested device identity evidence bottle), including a device identifier (e.g., a unique identifier of the threshold device) and a device attestation (e.g., an attestation of the threshold device indicating that the device is a trusted threshold device, running approved firmware versions).

In some embodiments, process 900 includes defining team attributes (block 906). This may include the team coordinator device determining member attributes (e.g., team rules) for the trusted execution environment. The attributes may include, for example, parameters for a voting scheme executed in the trusted execution environment (e.g., threshold number of shares for approval), voting policies, environment requirements, device requirements, attestation requirements, audit requirements, and missing piece requirements. Continuing with the prior example, defining team attributes may include an operator of device 106A configuring the Release Management Team with team attributes (e.g., team rules) of: (i) only enclave-based devices may serve as execution environments; (ii) a 3-of-4 threshold for reconstitution; (iii) audit logging required for all proposals; and (iv) missing piece service enabled for deployments.

In some embodiments, process 900 includes generating team proposal (block 908). This may include the team coordinator device generating a proposal that includes a team proposal identifier, and team attributes. Continuing with the prior example, generating a team proposal may include device 106A generating team proposal (e.g., a team proposal bottle) (TEAM-PROP-REL-001), specifying team members (devices 106B-D), and team attributes 3-of-4 share threshold, audit enabled, and missing piece enabled. In some embodiments, the team proposal is audited and attested.

In some embodiments, process 900 includes auditing team proposal (block 910). This may include auditing the team proposal to ensure it satisfies audit criteria and, when satisfied, providing an attestation that is indicative thereof. Such an audit may be conducted by a third-party audit service. Also, the attestation may accompany the team proposal to enable the receiving party to validate the team proposal or its sender. Continuing with the prior example, auditing the team proposal may include the threshold device 106A providing the team proposal (e.g., the team proposal bottle) to the audit device 110, and the audit device 110 confirming the credentials of the threshold device 106A, and, in turn, logging the team proposal identifier (TEAM-PROP-REL-001) in its ledger and returning, to the threshold device 106A a proposal attestation (e.g., a signature) (AUD-SIG-124) to accompany the team proposal, for authenticating the team proposal. In some embodiments, the team proposal includes attestations received from the team member devices, such as 106B-106D.

In some embodiments, process 900 includes distributing team proposal (block 912). This may include the team coordinator device sending the team proposal to team member devices of the trusted execution environment. Continuing with the prior example, distributing the team proposal may include the threshold device 106A sending the team proposal, a package (e.g., a bottle with the team proposal attestation (AUD-SIG-124), forming an attested team proposal bottle) that includes the proposal identifier (TEAM-PROP-REL-001) and specifying team members (devices 106B-D), and team attributes of 3-of-4 share threshold, audit enabled, and missing piece enabled, to each of team member devices 106B, 106C, and 106D. In some embodiments, the team proposal is distributed by a third party, such as the audit service, a coordinator, or the like. For example, the audit device 110 may distribute the team proposal to the team member devices 106B, 106C, and 106D, along with an attestation of the team proposal. The resulting packet may be referred to as an attested team proposal (e.g., an attested team proposal bottle).

In some embodiments, process 900 includes validating team proposal (block 914). This may include team member devices verifying that the team proposal is valid. For example, validating the team proposal may include verifying the authenticity of the team proposal, conducting policy checking of the team proposal, or the like. Continuing with the prior example, validating the team proposal may include device 106B verifying that dealer 106A is operating as a trusted execution environment (e.g., based on inspection of an attestation accompanying the team proposal), and that devices 106C and 106D qualify as valid shareholders under policy (e.g., based on inspection of confirmation of receipt of attestations from each of the devices 106C and 106D included with the team proposal), and confirming that team attributes 3-of-4 share threshold, audit enabled, and missing piece enabled are consistent with the policy of the trusted execution environment. A similar set of operations may be conducted for each of the other team member devices 106C and 106D.

In some embodiments, process 900 includes obtaining proposal approval (block 916). This may include querying an operator for approval of the team proposal. Continuing with the prior example, obtaining team proposal approval may include device 106B (e.g., responsive to validation of the team proposal) displaying attributes of the team proposal, such as “Team: Release Management Team”; “Threshold: 3-of-4”; “Audit: Enabled”; and “Missing piece: Enabled”, via a graphical user interface, and prompting its operator for approval/disapproval of the team proposal. This provides the operator with an opportunity to submit an approval/disapproval decision for the team proposal presented. A similar set of operations may be conducted for each of the other team member devices 106C and 106D.

In some embodiments, process 900 includes generating team join pledge (block 918). This may include team member devices generating a pledge that commits them to join the team. Each pledge by a device may include the team proposal identifier and a public receiver key corresponding to a private key of a cryptographic receiver key pair of the threshold device. The pledge may, for example, be provided in the form of a bottle (e.g., a team join pledge bottle), as described here. Continuing with the prior example, generating a team join pledge may include device 106B generating a cryptographic receiver key pair (RXKEY-PRV-001/RXKEY-PUB-001), and generating a team join pledge (e.g., a bottle) (JOIN-PLEDGE-REL-01), that includes the team proposal identifier (TEAM-PROP-REL-001) and the public receiver key (RXKEY-PUB-001). A similar set of operations may be conducted for each of the other team member devices 106C and 106D.

In some embodiments, process 900 includes auditing team join pledge (block 920). This may include auditing the team join pledge to ensure it satisfies audit criteria and, when satisfied, providing an attestation that is indicative thereof. Such an audit may be conducted by a third-party audit service. Also, the attestation may accompany the team join pledge to enable the receiving party to validate the team join pledge or its sender. Continuing with the prior example, auditing the team join pledge may include the threshold device 106B providing the team join pledge (e.g., the team join pledge bottle) to the audit device 110, and the audit device 110 confirming the credentials of the threshold device 106B, and, in turn, logging the team join pledge identifier (TEAM-PROP-REL-001) in its ledger and returning, to the threshold device 106B a team join pledge attestation (e.g., a signature) (AUD-SIG-125) to accompany the team join pledge, for authenticating the team join pledge. The resulting packet may be referred to as an attested team join pledge (e.g., an attested team join pledge bottle). A similar set of operations may be conducted for each of the other team member devices 106C and 106D.

In some embodiments, process 900 includes submitting team join pledge (block 922). This may include submission of a team join pledge from some or all of the team members to the dealer, which validates that each pledge is unique and from a different device (e.g., based on the unique identifiers and accompanying attestations). Continuing with the prior example, submitting join pledges may include device 106B, 106C, and 106D sending their team join pledges to the dealer device 106A, which collects the pledges from devices 106B, 106C, and 106D, and confirms all are unique based on their unique identifiers and accompanying attestations that can be used to verify the authenticity of the unique identifiers.

In some embodiments, process 900 includes generating root secret (block 924). This may include the dealer generating a root secret for the team to underpin future operations, such as for use in enabling execution of a proposal intent as described here. Continuing with the prior example, generating the root secret may include dealer device 106A generating the root secret (ROOT-REL-TEAM) for the team of devices.

In some embodiments, process 900 includes adding missing piece (block 926). This may include, where implementation of missing piece is part of the attributes for the team, the dealer fetching a missing piece from an external service and combining it with the root secret. This may include associating a missing piece with the root secret such that the missing piece is required to use the root secret to perform operations in the trusted execution environment. Continuing with the prior example, adding a missing piece may include dealer device 106A requesting a missing piece from a missing piece service, receiving a missing piece (MISSING-TEAM-PIECE-01) from the missing piece service, and combining it with root secret ROOT-REL-TEAM to form a missing piece root secret combination (e.g., MISSING-TEAM-PIECE-01/ROOT-REL-TEAM).

In some embodiments, process 900 includes generating team member certificates (block 928). This may include the team coordinator device generating shares of the root secret, each of the shares representing a portion of the root secret, generating subset of the shares of the root secret for each of the team member devices, encrypting the subset of the shares of the root secret for the team member devices (using the public receiver key for the target team member device), to generate encrypted sets of shares of the root secret, generating team member certificates for the team devices (each including the set of shares of the root secret for the target team member device), and sending the team member certificates to the respective target team member device for storage by the target team member device. Continuing with the prior example, generating team member certificates may include dealer 106A generating shares of the root secret, each of the shares representing a portion of the root secret, generating three subsets of the shares of the root secret for each of the team member devices 106B-106D, respectively, encrypting each subset of the shares of the root secret for each of the team member devices 106B-106D using the public receiver key for the team member device (e.g., encrypting the subset of the shares of the root secret for team member device 106B using the public receiver key (RXKEY-PUB-001)), to generate encrypted sets of shares of the root secret, generating team member certificates for the team devices (CERT-REL-B, CERT-REL-C, and CERT-REL-D), each including the encrypted sets of shares of the root secret for the respective target team member device, and sending to each of the respective team member devices, the respective certificate for the target team member device, for storage by the target team member device. The team member certificates may, for example, be provided in the form of a bottle (e.g., a team member certificate bottle), as described here.

In some embodiments, process 900 includes auditing team member certificates (block 930). This may include auditing the team member certificate to ensure it satisfies audit criteria and, when satisfied, providing an attestation that is indicative thereof. Such an audit may be conducted by a third-party audit service. Also, the attestation may accompany the team member certificate to enable the receiving party to validate the team member certificate or its sender. Continuing with the prior example, auditing the team member certificate may include the threshold device 106A providing the team member certificates (e.g., the team member certificate bottle) to the audit device 110, and the audit device 110 confirming the credentials of the threshold device 106A, and, in turn, logging the team member certificates (CERT-REL-B, CERT-REL-C, and CERT-REL-D) in its ledger and returning, to the threshold device 106A team member certificate attestations (e.g., signatures) (AUD-SIG-126) to accompany the team member certificates, for authenticating the team member certificates. In some embodiments, the team member certificates each include the associated attestations.

In some embodiments, process 900 includes generating team documentation (block 932). This may include the dealer generating a document summarizing team membership and policies. Continuing with the prior example, generating team documentation may include dealer 106A generating an authenticated document (TEAM-INFO-REL-001), signed with the dealer's key. In some embodiments, the team documentation is cryptographically attested, for example, as described here for the certificates.

In some embodiments, process 900 includes distributing team invitations (block 934). This may include the team coordinator device sending team invitations to team member devices of the trusted execution environment. In some embodiments, a team invitation for a team member device includes the team member certificate for the device, and, in some instances, the team documentation. Continuing with the prior example, distributing team invitations may include the threshold device 106A sending a team invitation (INVITE-REL-B), a package (e.g., an attested team invitation bottle) that includes the certificate (CERT-REL-B), its attestation AUD-SIG-126 (and the team documentation and its attestation) to team member device 106B, and sends a similar team member invitation to each of team member devices 106C (INVITE-REL-C) and 106D (INVITE-REL-D). In some embodiments, the team invitation is distributed by a third party, such as the audit service, a coordinator, or the like. For example, the audit device 110 may distribute the team invitation to the team member device 106B, along with an attestation of the certificate or the documentation. The resulting packet may be referred to as an attested team invitation (e.g., an attested team invitation bottle).

In some embodiments, process 900 includes validating team invitation (block 936). This may include team member devices verifying that the team invitation is valid. For example, validating the team invitation may include verifying the authenticity of the team invitation, conducting policy checking of the team invitation, or the like. Continuing with the prior example, validating the team invitation may include device 106B verifying that dealer 106A is operating as a trusted execution environment (e.g., based on inspection of an attestation accompanying the team invitation), and that the team invitation references valid proposal (TEAM-PROP-REL-001). A similar set of operations may be conducted for each of the other team member devices 106C and 106D.

In some embodiments, process 900 includes decrypting and storing shares (block 938). This may include each team member device decrypting its assigned share and securely storing the share with its membership certificate. Continuing with the prior example, decrypting and storing shares may include device 106B decrypting its share of the root secret (ROOT-REL-TEAM) using its receiver private key (RXKEY-PRV-001), and storing the decrypted set of shares, e.g., with its certificate (CERT-REL-B), in local memory, and confirming its team membership with a reply to dealer 106A.

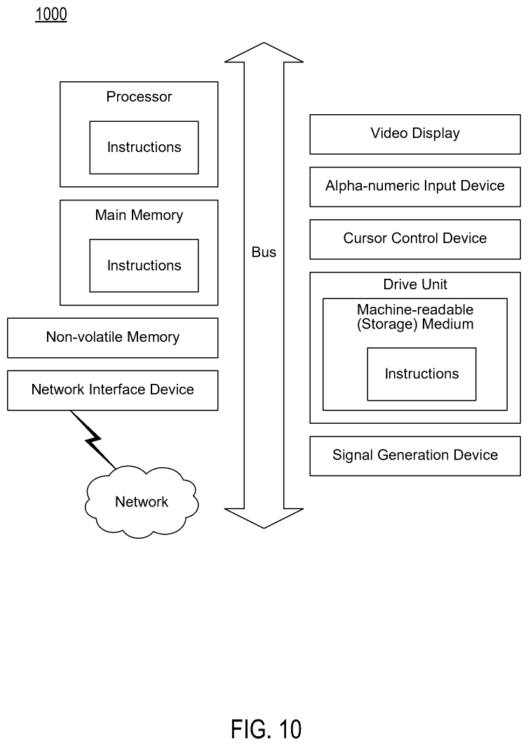

FIG. 10 depicts a diagrammatic representation of a machine in the example form of a computer system, according to some embodiments. Entities describe here, such as a threshold device 106, operator device 108, or auditor device 110, or other entity may be employed in the example form of a computer system 1000. The computer system 1000 may include a set of instructions that when executed cause the computer system to perform any one or more of the methodologies discussed herein.

In alternative embodiments, the machine operates as a standalone device or may be connected (networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone or smart phone, a tablet computer, a personal computer, a web appliance, a point-of-sale device, a network router, switch or bridge, or any machine capable of executing a set of instructions (sequential or otherwise) that specify actions to be taken by that machine.

While the machine-readable (storage) medium is shown in an exemplary embodiment to be a single medium, the term “machine-readable (storage) medium” should be taken to include a single medium or multiple media (a centralized or distributed database, and/or associated caches and servers) that store the one or more sets of instructions. The term “computer-readable medium”, “computer-readable storage medium”, “machine-readable medium” or “machine readable storage medium” shall also be taken to include any medium that is capable of storing, encoding or carrying a set of instructions for execution by the machine and that cause the machine to perform any one or more of the methodologies of the present invention. Embodiments may include non-transitory computer-readable storage medium (e.g., computer memory) storing program instructions that are executable by a processor (e.g., a computer processor) for causing performance of the operations described, such as those of the methods/processes described here.

In general, the routines executed to implement the embodiments of the disclosure, may be implemented as part of an operating system or a specific application, component, program, object, module or sequence of instructions referred to as “computer programs. ” The computer programs typically comprise one or more instructions set at various times in various memory and storage devices in a computer, and that, when read and executed by one or more processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually affect the distribution.

Further examples of machine or computer-readable media include, but are not limited to, non-transitory, recordable type media such as volatile and non-volatile memory devices, floppy and other removable disks, hard disk drives, optical disks (e.g., Compact Disk Read-Only Memory (CD ROMS), Digital Versatile Discs (DVDs), etc.), among others, and transmission type media such as digital and analog communication links.

Throughout this application, the word “may” is used in a permissive sense (meaning having the potential to), rather than the mandatory sense (meaning must). The words “include,” “including,” and “includes” mean including, but not limited to. Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used throughout this application, the singular forms “a,” “an,” and “the” include plural referents unless the content clearly indicates otherwise. Thus, for example, reference to “an element” may include a combination of two or more elements. As used herein, the terms “connected,” “coupled,” or any variant thereof, means any connection or coupling, either direct or indirect, between two or more elements; the coupling or connection between the elements can be physical, logical, or a combination thereof. As used throughout this application, the term “from” does not limit the associated operation to being directly from. Thus, for example, receiving an item “from” an entity may include receiving an item directly from the entity or indirectly from the entity (e.g., by way of an intermediary entity). Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list. That is, throughout this application, the term “or” is used in an inclusive sense, unless indicated otherwise. A description of an element including A or B may refer to the element including one or both of A and B. As used throughout this application, the phrase “based on” does not limit the associated operation to being solely based on a particular item. Thus, for example, processing “based on” data A may include processing based at least in part on data A and based at least in part on data B, unless the content clearly indicates otherwise. Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical, electronic or magnetic quantities within memories, registers, or other information storage devices, transmission devices, or display devices of the special purpose computer or similar special purpose electronic processing/computing device. These interpretive principles apply to the claims as well as the specification, unless the claim language clearly dictates otherwise.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. Elements and materials may be substituted for those illustrated and described here, parts and processes may be reversed or omitted, and certain features of the embodiments may be utilized independently, all as would be apparent to one skilled in the art after having the benefit of this description of the embodiments. For example, while processes or blocks are presented in a given order, alternative embodiments may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed in parallel or may be performed at different times. Further, any specific numbers noted herein are only examples: alternative implementations may employ differing values or ranges. Headings used here are for organizational purposes only and are not meant to be used to limit the scope of the description.

The teachings of the disclosure provided herein can be applied to other systems, not necessarily the system described above. The elements and acts of the various embodiments described above can be combined to provide further embodiments.

All patents, applications and references noted above, including any that may be listed in accompanying filing papers, are incorporated herein by reference. Aspects of the disclosure can be modified, if necessary, to employ the systems, functions, and concepts of the various references described above to provide yet further embodiments of the disclosure. To the extent any U.S. patents, U.S. patent applications, or other materials (e.g., articles) have been incorporated by reference herein, the text of such materials is only incorporated by reference to the extent that no conflict exists between such material and the statements and drawings set forth herein. In the event of such conflict, the text of the present document governs, and terms in this document should not be given a narrower or broader reading in virtue of the way in which those terms are used in other materials incorporated by reference.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in their implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, ¶6, other aspects may likewise be embodied as a means-plus-function claim, or in other forms, such as being embodied in a computer-readable medium. (Any claims intended to be treated under 35 U.S.C. § 112, ¶6 will begin with the words “means for.”) Accordingly, the applicant reserves the right to add additional claims after filing the application to pursue such additional claim forms for other aspects of the disclosure.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

The present techniques will be better understood with reference to the following enumerated embodiments:

### Example Embodiments: Reconstitution of Secret:

1. A method comprising:
   receiving a first request to reconstitute a secret;
   sending, to a set of threshold devices associated with group of the secret, a second request for a vote to reconstitute the secret;
   receiving, from a first threshold device, an approval vote from a first user, the first user associated with the first role;
   adding a share from the approval vote to a tally, the tally associated with the first role; and
   responsive to the tally exceeding a threshold number, reconstituting the secret.
2. The method of embodiment 1, wherein reconstituting the secret comprises recombining shares of the secret distributed among users that voted in response to the second request.
3. The method of embodiment 1 or 2, further comprising:
   transmitting, to the first threshold device, a graphic user interface (GUI) with interactive elements that allow the first user to select between the approval vote and a disapproval vote.
4. The method of embodiment 3, further comprising:
   transmitting, via the GUI, a request for a passcode from the first user before the first user can vote via the interactive elements.
5. The method of any one of embodiments 1-4, further comprising:
   responsive to the tally not exceeding the threshold number, sending, to an operator device, an alert that the vote did not pass.

### Example Embodiments: Shares Voting

1. a Method Comprising:
   receiving a request to split a secret into a plurality of shares, the request including identifiers of a plurality of users to each receive a share of the secret and a voting scheme;
   splitting the secret into a plurality shares;
   creating a certificate for a first user, wherein the certificate identifies the first user and shares allocated to the first user;
   allocating the certificate of the first user to a first threshold device;
   responsive to receiving, via the first threshold device, an approval vote for reconstitution of the secret, adding shares associated with the approval vote to a tally associated with the voting scheme; and
   responsive to the tally exceeding a threshold number, reconstituting the secret by combining the first user's share with other shares in the plurality of shares.
2. The method of embodiment 1, wherein the certificate is encoded with one or more roles of the first user, wherein the tally is associated with a first role, the method further comprising:
   responsive to determining the user is associated with the first role, adding the approval vote to the tally.
3. The method of embodiment 1 or 2, wherein allocating the certificate of the first user to the first threshold device is responsive to receiving, from an operator device, verification that the first threshold device is associated with the first user.
4. The method of any one of embodiment 1-3, wherein splitting the secret into the plurality of shares comprises:
   encrypting the share based on an identity of the first user and a type of the first threshold device; and
   sending the share to the first threshold device associated with the certificate.
5. The method of any one of embodiment 1-4, further comprising:
   requesting a critical piece for the secret; and
   responsive to not receiving the critical piece, preventing reconstitution of the secret.
6. The method of any one of embodiment 1-5, further comprising:
   creating a certificate for each of the plurality of users;
   allocating a share to each of the plurality of users, wherein the certificate of each user is associated with a share; and
   sending each certificate to a threshold device of each user in the plurality of users.

### Example Embodiments: Revocation

1. A method comprising:
   receiving, from a first threshold device of a first user in a first group of users, a request to revoke access to a secret for a second user in the first group of users;
   sending, to a threshold device of each user in the first group of users other than the first user and the second user, a request to revoke the second user's access to the secret;
   responsive to more than a threshold number of users from the first group voting to revoke the second user:
      reconstituting the secret with shares from the users that voted; sending an indication to each threshold device associated with the first group to delete its share of the secret;
      splitting the secret into a new set of shares; and
      distributing the new shares of the secret to the threshold devices of users in the second group of users.
2. The method of embodiment 1, wherein the new group of users includes the users from the group who voted to revoke the second user.
3. The method of embodiment 1 or 2, wherein the first group is associated with a first version and the second group is associated with a second version, the method further comprising:
   responsive to receiving, from a threshold device, a first request to reconstitute the first version of the secret, denying the request; and
      responsive to receiving, from a threshold device, a second request to reconstitute the second version of the secret, sending a request for a vote to the threshold devices of users in the second group.

### Example Embodiments: Voting Tiers

1. A method comprising:
   receiving a first request to reconstitute a secret, the secret associated with a voting scheme, wherein the voting scheme specifies a group of users, wherein the group of users includes a first tier and a second tier;
   sending, to a threshold device of each of the group of users, a second request for a vote to reconstitute the secret;
   receiving a first approval vote from a first threshold device:
   responsive to determining that a first user of the first threshold device is associated with the first tier, adding a share from the first approval vote to a first tally associated with the first tier;
   responsive to determining that the first user of the first threshold device is associated with the second tier, adding share from the first approval vote to a second tally associated with the second tier; and
   responsive to the first tally exceeding a first threshold number and the second tally exceeding a second threshold number, reconstituting the secret.
2. The method of embodiment 1, wherein the first tier includes a first subset and a second subset and the first tally includes a first sub-tally and a second sub-tally, the method further comprising:
   responsive to determining that the first user is associated with the first subset, adding the share to the first sub-tally; and
   responsive to determining that the first user is associated with the second subset, adding the share to the second sub-tally.
3. The method of embodiment 1 or 2, wherein receiving the approval vote from the first threshold device comprises one or more of receiving an electronic signature from the first threshold device, receiving a notification that the second request was logged, and receiving a password associated with the first threshold device.

### Example Embodiments: Voting/Execution

1. A method of secret-based operation execution in a trusted execution environment, the method comprising:
   obtaining, by a first threshold device, an operation intent, the first threshold device being one of multiple threshold devices of a trusted execution environment, the multiple threshold devices storing shares of a root secret for use in execution of an operation within the trusted execution environment;
   generating, by the first threshold device, a cryptographic key pair comprising a private key and a corresponding public key;
   generating, by the first threshold device based on the operation intent, a proposal comprising:
      a proposal identifier;
      the operation intent; and
      the public key;
   sending, by the first threshold device to a second threshold device of the multiple threshold devices of the trusted execution environment, the proposal, the second threshold device storing a subset of shares of the root secret;
   receiving, by the first threshold device from the second threshold device, an approval vote for the proposal, the approval vote comprising:
      the proposal identifier; and
      an encrypted set of shares comprising the subset of shares of the root secret encrypted using the public key;
   accumulating, by the first threshold device, votes from the threshold devices of the trusted execution environment, the accumulating comprising:
      decrypting, by the first threshold device using the private key, the encrypted set of shares to generate a decrypted subset of shares; and
      applying, by the first threshold device, the decrypted subset of shares toward a voting shares threshold;
   determining, by the first threshold device based on the accumulating, satisfaction of the voting shares threshold;
   reconstituting, by the first threshold device responsive to satisfaction of the voting shares threshold, the root secret using the decrypted subset of shares; and
   executing, by the first threshold device, the operation intent using the root secret reconstituted.
2. The method of embodiment 1, wherein the operation intent defines an operation to be executed in the trusted execution environment.
3. The method of embodiment 1, further comprising generating, by an audit service, an attestation of the proposal, wherein the attestation of the proposal is provided with the proposal sent from the first threshold device to the second threshold device.
4. The method of embodiment 1, further comprising:
   presenting, by the second threshold device to an operator, an indication of the operation intent of the proposal for approval; and
   receiving, by the second threshold device from the operator, an indication of approval of the proposal;
   encrypting, by the second threshold device, the subset of shares of the root secret using the public key to generate the set of encrypted shares; and
   generating, by the second threshold device, the approval vote for the proposal.
5. The method of embodiment 4, further comprising:
   conducting, by the second threshold device, a validation of the proposal, the validation of the proposal comprising one or more of verifying authenticity of the proposal based on an attestation and conducting a policy check of the proposal,
   wherein the approval vote for the proposal is generated based on the validation of the proposal.
6. The method of embodiment 1, further comprising generating, by the audit service, an attestation of the approval vote, wherein the attestation of the approval vote is provided with the approval vote sent from the second threshold device to the first threshold device.
7. The method of embodiment 1, further comprising:
   conducting, by the first threshold device, a validation check of the approval vote; and
   determining, based on the validation check, a validation of the approval vote,
   wherein the approval vote for the proposal is accumulated based on the validation of the approval vote.
8. The method of embodiment 1, wherein executing the operation intent using the root secret comprises generating a signing key using the root secret reconstituted.
9. The method of embodiment 1, further comprising:
   receiving, by the first threshold device from a missing piece service, a missing piece, wherein executing the operation intent using the root secret comprises executing the operation using the missing piece in combination with the root secret reconstituted.
10. The method of embodiment 1, further comprising:
   distributing, by the first threshold device to a third threshold device of the multiple threshold devices of the trusted execution environment, the proposal, the third threshold device storing a second subset of shares of the root secret;
   receiving, by the first threshold device, a second approval vote for the proposal, the second approval vote comprising:
   the proposal identifier;
   a second encrypted set of shares comprising the second subset of shares of the root secret encrypted using the public key,
   wherein the accumulating votes from the threshold devices of the trusted execution environment comprises:
   decrypting, by the first threshold device using the private key, the second encrypted set of shares to generate a second decrypted subset of shares; and
   applying the second decrypted subset of shares toward the voting shares threshold.
11. A system for secret-based operation execution in a trusted execution environment, the system comprising:
   a first threshold device, the first threshold device being one of multiple threshold devices of a trusted execution environment, the multiple threshold devices storing shares of a root secret for use in execution of an operation within the trusted execution environment,
   the first threshold device configured to perform the following operations:
   determine an operation intent;
   generate a cryptographic key pair comprising a private key and a corresponding public key;
   generate, based on the operation intent, a proposal comprising:
      a proposal identifier;
      the operation intent; and
      the public key;
   send, to a second threshold device of the multiple threshold devices of the trusted execution environment, the proposal, the second threshold device storing a subset of shares of the root secret;
   receive, from the second threshold device, an approval vote for the proposal, the approval vote comprising:
      the proposal identifier; and
      an encrypted set of shares comprising the subset of shares of the root secret encrypted using the public key;
   accumulate votes from the threshold devices of the trusted execution environment, the accumulating comprising:
      decrypting, using the private key, the encrypted set of shares to generate a decrypted subset of shares; and
      applying, by the first threshold device, the decrypted subset of shares toward a voting shares threshold;
   determine, based on the accumulating of votes, satisfaction of the voting shares threshold;
   reconstitute, responsive to satisfaction of the voting shares threshold, the root secret; and
   execute the operation intent using the root secret reconstituted.
12. The system of embodiment 11, wherein the operation intent defines an operation to be executed in the trusted execution environment.
13. The system of embodiment 11, wherein an audit service generates an attestation of the proposal, and wherein the attestation of the proposal is provided with the proposal sent from the first threshold device to the second threshold device.
14. The system of embodiment 11, further comprising the second threshold device configured to perform the following operations:
   present, to an operator, an indication of the operation intent of the proposal for approval; and
   receive, from the operator, an indication of approval of the proposal;
   encrypt the subset of shares of the root secret using the public key to generate the set of encrypted shares; and
   generate the approval vote for the proposal.
15. The system of embodiment 14, further comprising the second threshold device configured to perform the following operations:
   conduct, by the second threshold device, a policy validation of the proposal, the validation of the proposal comprising one or more of verifying authenticity of the proposal based on an attestation and conducting a policy check of the proposal; and
   determine, based on the policy check, an initial approval of the proposal,
   wherein the approval vote for the proposal is generated based on the validation of the initial approval of the proposal.
16. The system of embodiment 11, wherein an audit service generates an attestation of the approval vote, and wherein the attestation of the approval vote is provided with the approval vote sent from the second threshold device to the first threshold device.
17. The system of embodiment 11, the operations further comprising:
   conduct a validation check of the approval vote; and
   determine, based on the validation check, a validation of the approval vote,
   wherein the approval vote for the proposal is accumulated based on the validation of the approval vote.
18. The system of embodiment 11, wherein executing the operation intent using the root secret comprises generating a signing key using the root secret reconstituted.
19. The system of embodiment 11, the operations further comprising:
   receive, from a missing piece service, a missing piece,
   wherein executing the operation intent using the root secret comprises executing the operation using the missing piece in combination with the root secret reconstituted.
20. The system of embodiment 11, the operations further comprising:
   distribute, to a third threshold device of the multiple threshold devices of the trusted execution environment, the proposal, the third threshold device storing a second subset of shares of the root secret;
   receive a second approval vote for the proposal, the second approval vote comprising:
      the proposal identifier; and
      a second encrypted set of shares comprising the second subset of shares of the root secret encrypted using the public key, and
   wherein the accumulating votes from the threshold devices of the trusted execution environment comprises:
      decrypting, using the private key, the second encrypted set of shares to generate a second decrypted subset of shares; and
      applying the second decrypted subset of shares toward the voting shares threshold.
21. A non-transitory computer-readable storage medium storing programs instructions that are executable by a processor for performing the following operations for secret-based operation execution in a trusted execution environment:
   obtaining, by a first threshold device, an operation intent, the first threshold device being one of multiple threshold devices of a trusted execution environment, the multiple threshold devices storing shares of a root secret for use in execution of an operation within the trusted execution environment;
   generating, by the first threshold device, a cryptographic key pair comprising a private key and a corresponding public key;
   generating, by the first threshold device based on the operation intent, a proposal comprising:
      a proposal identifier;
      the operation intent; and
      the public key;
   sending, by the first threshold device to a second threshold device of the multiple threshold devices of the trusted execution environment, the proposal, the second threshold device storing a subset of shares of the root secret;
   receiving, by the first threshold device from the second threshold device, an approval vote for the proposal, the approval vote comprising:
      the proposal identifier; and
      an encrypted set of shares comprising the subset of shares of the root secret encrypted using the public key;
   accumulating, by the first threshold device, votes from the threshold devices of the trusted execution environment, the accumulating comprising:
      decrypting, by the first threshold device using the private key, the encrypted set of shares to generate a decrypted subset of shares; and
      applying, by the first threshold device, the decrypted subset of shares toward a voting shares threshold;
   determining, by the first threshold device based on the accumulating, satisfaction of the voting shares threshold;
   reconstituting, by the first threshold device responsive to satisfaction of the voting shares threshold, the root secret using the decrypted subset of shares; and
   executing, by the first threshold device, the operation intent using the root secret reconstituted.
22. A method comprising:
   sending, by a first device to a second device, a proposal, the proposal comprising:
      a proposal identifier;
      an operation intent; and
      a public key of a cryptographic key pair comprising the public key and a corresponding private key;
   receiving, by the first device from the second device, an approval vote for the proposal, the approval vote comprising:
      the proposal identifier; and
      an encrypted set of shares comprising a subset of shares of a root secret encrypted using the public key;
   decrypting, by the first device using the private key, the encrypted set of shares to generate a decrypted subset of shares;
   determining, by the first device based on applying the decrypted subset of shares toward a voting shares threshold, satisfaction of the voting shares threshold;
   reconstituting, by the first device responsive to the satisfaction of the voting shares threshold, the root secret using the decrypted subset of shares; and
   executing, by the first threshold device, the operation intent using the root secret reconstituted.
23. A non-transitory computer-readable storage medium storing programs instructions that are executable by a processor for performing the method operations of any one of the method embodiments 1-10 and 22.
24. A system configured to perform the method operations of any one of the method embodiments 1-10 and 22.

### Example Embodiments: Team Formation

1. A method of trusted execution environment formation, the method comprising:
   obtaining, by a first threshold device, a team specification, the team specification identifying a team of threshold devices of a trusted execution environment, identifying the first threshold device as a team coordinator device, and identifying a second threshold device of the threshold devices as a team member device;
   receiving, by the first threshold device from the second threshold device, second threshold device identity evidence comprising:
      a second device identifier comprising a unique identifier of the second threshold device; and
      a second device attestation comprising an attestation of the second threshold device;
   determining, by the first threshold device, member attributes for the trusted execution environment;
   generating, by the first threshold device based on the member attributes, a team proposal comprising:
      a team proposal identifier; and
      the team attributes;
   sending, by the first threshold device to the second threshold device, the team proposal;
   receiving, by the first threshold device from the second threshold device, a team join pledge comprising:
      the team proposal identifier; and
      a public key corresponding to a private key of a cryptographic key pair of the second threshold device;
   generating, by the first threshold device, a root secret for the team of threshold devices;
   generating, by the first threshold device, shares of the root secret, each of the shares representing a portion of the root secret;
   generating, by the first threshold device, a first subset of the shares of the root secret;
   encrypting, by the first threshold device using the public key, the first subset of the shares of the root secret to generate a first encrypted set of shares of the root secret; and
   sending, by the first threshold device to the second threshold device, a team member certificate comprising the first encrypted set of shares of the root secret for storage by the second threshold device.
2. The method of embodiment 1, wherein the member attributes for the trusted execution environment define parameters for a voting scheme executed in the trusted execution environment.
3. The method of embodiment 1, wherein the member attributes for the trusted execution environment define one or more of: voting policies, environment requirements, device requirements, attestation requirements, audit requirements, and missing piece requirements.
4. The method of embodiment 1, further comprising the second threshold device of the threshold devices validating the team proposal.
5. The method of embodiment 1, further comprising:
   presenting, by the second threshold device to an operator, an indication of the team attributes of the team proposal for approval;
   receiving, by the second threshold device from the operator, an indication of approval of the team proposal,
   the team join pledge generated by the second threshold device responsive to receipt of the indication of approval of the team proposal.
6. The method of embodiment 1, further comprising:
   generating, by the second threshold device, the cryptographic key pair comprising the public key and the corresponding private key.
7. The method of embodiment 1, further comprising:
   receiving, by the first threshold device from a missing piece service, a missing piece; and
   associating, by the first threshold device, the missing piece with the root secret such that the missing piece is required to use the root secret to perform operations in the trusted execution environment.
8. The method of embodiment 1, further comprising generating, by an audit service, an attestation of the first team member certificate, wherein the attestation of the first team member certificate is provided with the first team member certificate sent from the first threshold device to the second threshold device.
9. The method of embodiment 1, further comprising storing, by the second threshold device, the first encrypted set of shares of the root secret.
10. The method of embodiment 1, further comprising sending, by the second threshold device to a threshold device in response to a proposal comprising an operation intent, a vote comprising an encrypted version of set of shares of the root secret.
11. The method of embodiment 1, the team specification identifying a third threshold device of the threshold devices as a team member device, the method further comprising:
   receiving, by the first threshold device from the third threshold device, third threshold device identity evidence comprising:
      a third device identifier comprising a unique identifier of the third threshold device; and
      a third device attestation comprising an attestation of the third threshold device;
   sending, by the first threshold device to the third threshold device, the team proposal;
   receiving, by the first threshold device from the third threshold device, a second team join pledge comprising:
      the team proposal identifier; and
      a second public key corresponding to a second private key of a second cryptographic key pair of the third threshold device;
   generating, by the first threshold device, a second subset of the shares of the root secret;
   encrypting, by the first threshold device using the second public key, the second subset of the shares of the root secret to generate a second encrypted set of shares of the root secret; and
   sending, by the first threshold device to the third threshold device, a second team member certificate comprising the second encrypted set of shares of the root secret for storage by the third threshold device.
12. A system for trusted execution environment formation, the system comprising:
   a first threshold device of a team of threshold devices of a trusted execution environment,
   the first threshold device configured to perform the following operations:
   obtain a team specification, the team specification identifying the team of threshold devices of the trusted execution environment, identifying the first threshold device as a team coordinator device, and identifying a second threshold device of the threshold devices as a team member device;
   receive, from the second threshold device, second threshold device identity evidence comprising:
      a second device identifier comprising a unique identifier of the second threshold device; and
      a second device attestation comprising an attestation of the second threshold device;
   determine member attributes for the trusted execution environment;
   generate, based on the member attributes, a team proposal comprising:
      a team proposal identifier; and
      the team attributes;
   send, to the second threshold device, the team proposal;
   receive, from the second threshold device, a team join pledge comprising:
      the team proposal identifier; and
      a public key corresponding to a private key of a cryptographic key pair of the second threshold device;
   generate a root secret for the team of threshold devices;
   generate shares of the root secret, each of the shares representing a portion of the root secret;
   generate a first subset of the shares of the root secret;
   encrypt, using the public key, the first subset of the shares of the root secret to generate a first encrypted set of shares of the root secret; and
   send, to the second threshold device, a team member certificate comprising the first encrypted set of shares of the root secret for storage by the second threshold device.
13. The system of embodiment 12, wherein the member attributes for the trusted execution environment define parameters for a voting scheme executed in the trusted execution environment.
14. The system of embodiment 12, wherein the member attributes for the trusted execution environment define one or more of: voting policies, environment requirements, device requirements, attestation requirements, audit requirements, and missing piece requirements.
15. The system of embodiment 12, further comprising the second threshold device configured to validate the team proposal.
16. The system of embodiment 12, further comprising the second threshold device configured to perform the following operations:
   present, to an operator, an indication of the team attributes of the team proposal for approval;
   receive, from the operator, an indication of approval of the team proposal,
   generate the team join pledge responsive to receipt of the indication of approval of the team proposal.
17. The system of embodiment 12, further comprising the second threshold device configured to generate the cryptographic key pair comprising the public key and the corresponding private key.
18. The system of embodiment 12, the operations further comprising:
   receiving, from a missing piece service, a missing piece; and
   associating the missing piece with the root secret such that the missing piece is required to use the root secret to perform operations in the trusted execution environment.
19. The system of embodiment 12, wherein an audit service generates an attestation of the first team member certificate, and wherein the attestation of the first team member certificate is provided with the first team member certificate sent from the first threshold device to the second threshold device.
20. The system of embodiment 12, further comprising the second threshold device configured to store the first encrypted set of shares of the root secret.
21. The system of embodiment 12, further comprising the second threshold device configured to send, to a threshold device in response to a proposal comprising an operation intent, a vote comprising an encrypted version of set of shares of the root secret.
22. The system of embodiment 12, the team specification identifying a third threshold device of the threshold devices as a team member device, the operations further comprising:
   receive, from the third threshold device, third threshold device identity evidence comprising:
      a third device identifier comprising a unique identifier of the third threshold device; and
      a third device attestation comprising an attestation of the third threshold device;
   send, to the third threshold device, the team proposal;
   receive, from the third threshold device, a second team join pledge comprising:
      the team proposal identifier; and
      a second public key corresponding to a second private key of a second cryptographic key pair of the third threshold device;
   generate a second subset of the shares of the root secret;
   encrypt, using the second public key, the second subset of the shares of the root secret to generate a second encrypted set of shares of the root secret; and
   send, to the third threshold device, a second team member certificate comprising the second encrypted set of shares of the root secret for storage by the third threshold device.
23. A non-transitory computer-readable storage medium storing programs instructions that are executable by a processor for performing the following operations for trusted execution environment formation:
   obtaining, by a first threshold device, a team specification, the team specification identifying a team of threshold devices of a trusted execution environment, identifying the first threshold device as a team coordinator device, and identifying a second threshold device of the threshold devices as a team member device;
   receiving, by the first threshold device from the second threshold device, second threshold device identity evidence comprising:
      a second device identifier comprising a unique identifier of the second threshold device; and
      a second device attestation comprising an attestation of the second threshold device;
   determining, by the first threshold device, member attributes for the trusted execution environment;
   generating, by the first threshold device based on the member attributes, a team proposal comprising:
      a team proposal identifier; and
      the team attributes;
   sending, by the first threshold device to the second threshold device, the team proposal;
   receiving, by the first threshold device from the second threshold device, a team join pledge comprising:
      the team proposal identifier; and
      a public key corresponding to a private key of a cryptographic key pair of the second threshold device;
   generating, by the first threshold device, a root secret for the team of threshold devices;
   generating, by the first threshold device, shares of the root secret, each of the shares representing a portion of the root secret;
   generating, by the first threshold device, a first subset of the shares of the root secret;
   encrypting, by the first threshold device using the public key, the first subset of the shares of the root secret to generate a first encrypted set of shares of the root secret; and
   sending, by the first threshold device to the second threshold device, a team member certificate comprising the first encrypted set of shares of the root secret for storage by the second threshold device.
24. A method comprising:
   receiving, by a first device from a second device, second device identity evidence comprising:
      a second device identifier; and
      a second device attestation;
   generating, by the first device, a team proposal comprising:
      a team proposal identifier; and
      team attributes;
   sending, by the first device to the second device, the team proposal;
   receiving, by the first device from the second device, a team join pledge comprising:
      the team proposal identifier; and
      a public key corresponding to a private key of a cryptographic key pair;
   generating, by the first device, a root secret;
   generating, by the first device, shares of the root secret;
   generating, by the first device, a first subset of the shares of the root secret;
   encrypting, by the first device using the public key, the first subset of the shares of the root secret to generate a first encrypted set of shares of the root secret; and
   sending, by the first device to the second device, the first encrypted set of shares of the root secret for storage by the second device.
25. A non-transitory computer-readable storage medium storing programs instructions that are executable by a processor for performing the method operations of any one of the method embodiments 1-11 and 24.
26. A system configured to perform the method operations of any one of the method embodiments 1-11 and 24.

What is claimed is:

1. A method of trusted execution environment formation, the method comprising:
obtaining, by a first threshold device, a team specification, the team specification identifying a team of threshold devices of a trusted execution environment, identifying the first threshold device as a team coordinator device, and identifying a second threshold device of the threshold devices as a team member device;
receiving, by the first threshold device from the second threshold device, second threshold device identity evidence comprising:
a second device identifier comprising a unique identifier of the second threshold device; and
a second device attestation comprising an attestation of the second threshold device;
determining, by the first threshold device, member attributes for the trusted execution environment;
generating, by the first threshold device based on the member attributes, a team proposal comprising:
a team proposal identifier; and
the team attributes;
sending, by the first threshold device to the second threshold device, the team proposal;
receiving, by the first threshold device from the second threshold device, a team join pledge comprising:
the team proposal identifier; and
a public key corresponding to a private key of a cryptographic key pair of the second threshold device;
generating, by the first threshold device, a root secret for the team of threshold devices;
generating, by the first threshold device, shares of the root secret, each of the shares representing a portion of the root secret;
generating, by the first threshold device, a first subset of the shares of the root secret;
encrypting, by the first threshold device using the public key, the first subset of the shares of the root secret to generate a first encrypted set of shares of the root secret; and
sending, by the first threshold device to the second threshold device, a team member certificate comprising the first encrypted set of shares of the root secret for storage by the second threshold device.

2. The method of claim 1, wherein the member attributes for the trusted execution environment define parameters for a voting scheme executed in the trusted execution environment.

3. The method of claim 1, wherein the member attributes for the trusted execution environment define one or more of: voting policies, environment requirements, device requirements, attestation requirements, audit requirements, and missing piece requirements.

4. The method of claim 1, further comprising the second threshold device of the threshold devices validating the team proposal.

5. The method of claim 1, further comprising:
presenting, by the second threshold device to an operator, an indication of the team attributes of the team proposal for approval;
receiving, by the second threshold device from the operator, an indication of approval of the team proposal,
the team join pledge generated by the second threshold device responsive to receipt of the indication of approval of the team proposal.

6. The method of claim 1, further comprising:
generating, by the second threshold device, the cryptographic key pair comprising the public key and the corresponding private key.

7. The method of claim 1, further comprising:
receiving, by the first threshold device from a missing piece service, a missing piece; and
associating, by the first threshold device, the missing piece with the root secret such that the missing piece is required to use the root secret to perform operations in the trusted execution environment.

8. The method of claim 1, further comprising generating, by an audit service, an attestation of the first team member certificate, wherein the attestation of the first team member certificate is provided with the first team member certificate sent from the first threshold device to the second threshold device.

9. The method of claim 1, further comprising storing, by the second threshold device, the first encrypted set of shares of the root secret.

10. The method of claim 1, further comprising sending, by the second threshold device to a threshold device in response to a proposal comprising an operation intent, a vote comprising an encrypted version of set of shares of the root secret.

11. The method of claim 1, the team specification identifying a third threshold device of the threshold devices as a team member device, the method further comprising:
receiving, by the first threshold device from the third threshold device, third threshold device identity evidence comprising:
a third device identifier comprising a unique identifier of the third threshold device; and
a third device attestation comprising an attestation of the third threshold device;
sending, by the first threshold device to the third threshold device, the team proposal;
receiving, by the first threshold device from the third threshold device, a second team join pledge comprising:
the team proposal identifier; and
a second public key corresponding to a second private key of a second cryptographic key pair of the third threshold device;
generating, by the first threshold device, a second subset of the shares of the root secret;
encrypting, by the first threshold device using the second public key, the second subset of the shares of the root secret to generate a second encrypted set of shares of the root secret; and
sending, by the first threshold device to the third threshold device, a second team member certificate comprising the second encrypted set of shares of the root secret for storage by the third threshold device.

12. A system for trusted execution environment formation, the system comprising:
a first threshold device of a team of threshold devices of a trusted execution environment, the first threshold device configured to perform the following operations:
obtain a team specification, the team specification identifying the team of threshold devices of the trusted execution environment, identifying the first threshold device as a team coordinator device, and identifying a second threshold device of the threshold devices as a team member device;
receive, from the second threshold device, second threshold device identity evidence comprising:
a second device identifier comprising a unique identifier of the second threshold device; and
a second device attestation comprising an attestation of the second threshold device;
determine member attributes for the trusted execution environment;
generate, based on the member attributes, a team proposal comprising:
a team proposal identifier; and
the team attributes;
send, to the second threshold device, the team proposal;
receive, from the second threshold device, a team join pledge comprising:
the team proposal identifier; and
a public key corresponding to a private key of a cryptographic key pair of the second threshold device;
generate a root secret for the team of threshold devices;
generate shares of the root secret, each of the shares representing a portion of the root secret;
generate a first subset of the shares of the root secret;
encrypt, using the public key, the first subset of the shares of the root secret to generate a first encrypted set of shares of the root secret; and
send, to the second threshold device, a team member certificate comprising the first encrypted set of shares of the root secret for storage by the second threshold device.

13. The system of claim 12, wherein the member attributes for the trusted execution environment define parameters for a voting scheme executed in the trusted execution environment.

14. The system of claim 12, wherein the member attributes for the trusted execution environment define one or more of: voting policies, environment requirements, device requirements, attestation requirements, audit requirements, and missing piece requirements.

15. The system of claim 12, further comprising the second threshold device configured to validate the team proposal.

16. The system of claim 12, further comprising the second threshold device configured to perform the following operations:
present, to an operator, an indication of the team attributes of the team proposal for approval;
receive, from the operator, an indication of approval of the team proposal,
generate the team join pledge responsive to receipt of the indication of approval of the team proposal.

17. The system of claim 12, further comprising the second threshold device configured to generate the cryptographic key pair comprising the public key and the corresponding private key.

18. The system of claim 12, the operations further comprising:
receiving, from a missing piece service, a missing piece; and
associating the missing piece with the root secret such that the missing piece is required to use the root secret to perform operations in the trusted execution environment.

19. The system of claim 12, wherein an audit service generates an attestation of the first team member certificate, and wherein the attestation of the first team member certificate is provided with the first team member certificate sent from the first threshold device to the second threshold device.

20. The system of claim 12, further comprising the second threshold device configured to store the first encrypted set of shares of the root secret.

21. The system of claim 12, further comprising the second threshold device configured to send, to a threshold device in response to a proposal comprising an operation intent, a vote comprising an encrypted version of set of shares of the root secret.

22. The system of claim 12, the team specification identifying a third threshold device of the threshold devices as a team member device, the operations further comprising:
receive, from the third threshold device, third threshold device identity evidence comprising:
a third device identifier comprising a unique identifier of the third threshold device; and
a third device attestation comprising an attestation of the third threshold device;
send, to the third threshold device, the team proposal;
receive, from the third threshold device, a second team join pledge comprising:
the team proposal identifier; and
a second public key corresponding to a second private key of a second cryptographic key pair of the third threshold device;
generate a second subset of the shares of the root secret;
encrypt, using the second public key, the second subset of the shares of the root secret to generate a second encrypted set of shares of the root secret; and
send, to the third threshold device, a second team member certificate comprising the second encrypted set of shares of the root secret for storage by the third threshold device.

23. A non-transitory computer-readable storage medium storing programs instructions that are executable by a processor for performing the following operations for trusted execution environment formation:
obtaining, by a first threshold device, a team specification, the team specification identifying a team of threshold devices of a trusted execution environment, identifying the first threshold device as a team coordinator device, and identifying a second threshold device of the threshold devices as a team member device;
receiving, by the first threshold device from the second threshold device, second threshold device identity evidence comprising:
a second device identifier comprising a unique identifier of the second threshold device; and
a second device attestation comprising an attestation of the second threshold device;
determining, by the first threshold device, member attributes for the trusted execution environment;
generating, by the first threshold device based on the member attributes, a team proposal comprising:
a team proposal identifier; and
the team attributes;
sending, by the first threshold device to the second threshold device, the team proposal;
receiving, by the first threshold device from the second threshold device, a team join pledge comprising:
the team proposal identifier; and
a public key corresponding to a private key of a cryptographic key pair of the second threshold device;
generating, by the first threshold device, a root secret for the team of threshold devices;
generating, by the first threshold device, shares of the root secret, each of the shares representing a portion of the root secret;
generating, by the first threshold device, a first subset of the shares of the root secret;
encrypting, by the first threshold device using the public key, the first subset of the shares of the root secret to generate a first encrypted set of shares of the root secret; and
sending, by the first threshold device to the second threshold device, a team member certificate comprising the first encrypted set of shares of the root secret for storage by the second threshold device.

24. A method comprising:
receiving, by a first device from a second device, second device identity evidence comprising:
a second device identifier; and
a second device attestation;
generating, by the first device, a team proposal comprising:
a team proposal identifier; and
team attributes;
sending, by the first device to the second device, the team proposal;
receiving, by the first device from the second device, a team join pledge comprising:
the team proposal identifier; and
a public key corresponding to a private key of a cryptographic key pair;
generating, by the first device, a root secret;
generating, by the first device, shares of the root secret;
generating, by the first device, a first subset of the shares of the root secret;
encrypting, by the first device using the public key, the first subset of the shares of the root secret to generate a first encrypted set of shares of the root secret; and
sending, by the first device to the second device, the first encrypted set of shares of the root secret for storage by the second device.
